(19) United States
(12) Patent Application Publication
(10) Pub. No.: US 2022/0322375 A1
(43) Pub. Date: Oct. 6, 2022

(54) METHOD AND APPARATUS FOR RECEIVING DOWNLINK SIGNAL IN A WIRELESS COMMUNICATION SYSTEM

(71) Applicant: ASUSTek Computer Inc., Taipei City (TW)

(72) Inventors: Chun-Wei Huang, Taipei City (TW); Ming-Che Li, Taipei City (TW)

(21) Appl. No.: 17/707,411

(22) Filed: Mar. 29, 2022

Related U.S. Application Data
(60) Provisional application No. 63/167,336, filed on Mar. 29, 2021.

(51) Int. Cl. H04W 72/12; H04W 72/04

(52) U.S. Cl. CPC H04W 72/1242; H04W 72/1273; H04W 72/1289; H04W 72/044; H04W 72/048

(57) ABSTRACT

A method and apparatus are disclosed from the perspective of a UE. The UE receives one or more SPS configurations associated to a BWP, wherein based on the one or more SPS configurations, there are more than one SPS PDSCHs in a slot comprising at least a first set of SPS PDSCHs associated to a first cast type and a second set of SPS PDSCHs associated to a second cast type. The UE also prioritizes a first SPS PDSCH with lowest SPS configuration index among the first set of SPS PDSCHs. Furthermore, the UE prioritizes a second SPS PDSCH with lowest SPS configuration index among the second set of SPS PDSCHs. In addition, the UE receives and/or decodes the prioritized first SPS PDSCH and the prioritized second SPS PDSCH, wherein the second SPS PDSCH and the first SPS PDSCH are time domain overlapping and frequency domain non-overlapping.

### CROSS-REFERENCE TO RELATED APPLICATIONS

The present Application claims the benefit of U.S. Provisional Patent Application Ser. No. 63/167,336 filed on Mar. 29, 2021, the entire disclosure of which is incorporated herein in their entirety by reference.

### FIELD

This disclosure generally relates to wireless communication networks, and more particularly, to a method and apparatus for receiving downlink signal in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a User Equipment (UE). In one embodiment, the method includes the UE receiving one or more Semi-Persistent Scheduling (SPS) configurations associated to a Bandwidth Part (BWP), wherein based on the one or more SPS configurations, there are more than one SPS Physical Downlink Shared Channels (PDSCHs) in a slot comprising at least a first set of SPS PDSCHs associated to a first cast type and a second set of SPS PDSCHs associated to a second cast type. The method further includes the UE prioritizing a first SPS PDSCH with lowest SPS configuration index among the first set of SPS PDSCHs. The method also includes the UE prioritizing a second SPS PDSCH with lowest SPS configuration index among the second set of SPS PDSCHs. Furthermore, the method includes the UE receiving and/or decoding the prioritized first SPS PDSCH and the prioritized second SPS PDSCH, wherein the second SPS PDSCH and the first SPS PDSCH are time domain overlapping and frequency domain non-overlapping.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Table 7.3.1-1 of 3GPP TS 38.212 V16.4.0.

FIG. 6 is a reproduction of Table 10.2-1 of 3GPP TS 38.213 V16.4.0.

FIG. 7 is a reproduction of Table 10.2-2 of 3GPP TS 38.213 V16.4.0.

FIG. 8 is a reproduction of Table 10.2-3 of 3GPP TS 38.213 V16.4.0.

FIG. 9 is a reproduction of Table 10.2-4 of 3GPP TS 38.213 V16.4.0.

FIG. 10 is a diagram according to one exemplary embodiment.

FIG. 11 is a diagram according to one exemplary embodiment.

FIG. 12 is a diagram according to one exemplary embodiment.

FIG. 13 is a diagram according to one exemplary embodiment.

FIG. 14 is a diagram according to one exemplary embodiment.

FIG. 15 is a diagram according to one exemplary embodiment.

FIG. 16 is a diagram according to one exemplary embodiment.

FIG. 17 is a diagram according to one exemplary embodiment.

FIG. 18 is a diagram according to one exemplary embodiment.

FIG. 19 is a diagram according to one exemplary embodiment.

FIG. 20 is a diagram according to one exemplary embodiment.

FIG. 21 is a flow chart according to one exemplary embodiment.

FIG. 22 is a flow chart according to one exemplary embodiment.

FIGS. 23A and 23B are a flow chart according to one exemplary embodiment.

FIG. 24 is a flow chart according to one exemplary embodiment.

FIG. 25 is a flow chart according to one exemplary embodiment.

FIG. 26 is a flow chart according to one exemplary embodiment.

FIG. 27 is a flow chart according to one exemplary embodiment.

FIG. 28 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems devices described below may be designed to support one or more standards such as the standard offered by a consortium named “3rd Generation Partnership Project” referred to herein as 3GPP, including: RP-201038, “Revised Work Item on NR Multicast and Broadcast Services”, Huawei, HiSilicon; Chairman Notes, 3GPP TSG RAN WG1 meeting #102-e, e-Meeting, Aug. 17^{th}-28^{th} 2020; Chairman Notes, 3GPP TSG RAN WG1 meeting #103-e, e-Meeting, Oct. 26^{th}-Nov. 13^{th} 2020; Chairman Notes, 3GPP TSG RAN WG1 meeting #104-e, e-Meeting, Jan. 25^{th}-Feb. 5^{th} 2020; TS 38.212 V16.4.0 (2020-12), “NR; Multiplexing and channel coding (Release 16)”; TS 38.213 V16.4.0 (2020-12), “NR; Physical layer procedures for control (Release 16)”; TS 38.331 V16.3.1 (2021-01), “3GPP TSG RAN; NR; Radio Resource Control (RRC) protocol specification (Release 16)”; TS 38.214 V16.4.0 (2020-12), “NR; Physical layer procedures for data (Release 16)”; TS 38.321 V16.3.0 (2020-12), “NR; Medium Access Control (MAC) protocol specification (Release 16)”; and R1-2100354, “Discussion on group scheduling mechanism for RRC_CONNECTED UEs in MBS”, CATT. The standards and documents listed above are hereby expressly incorporated by reference in their entirety.

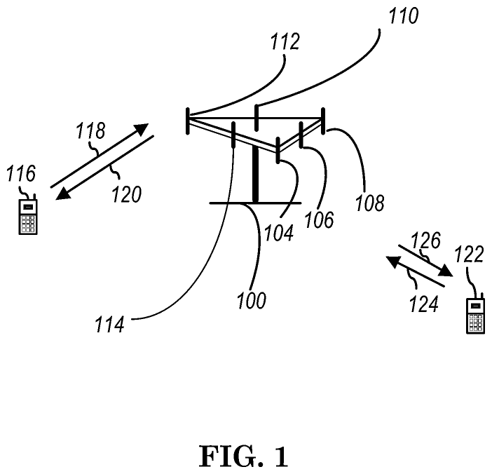

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

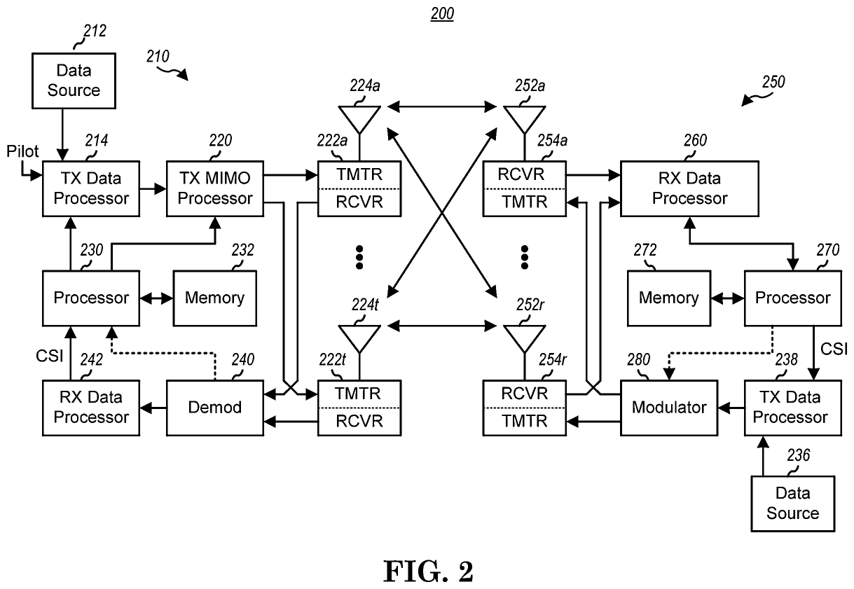

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

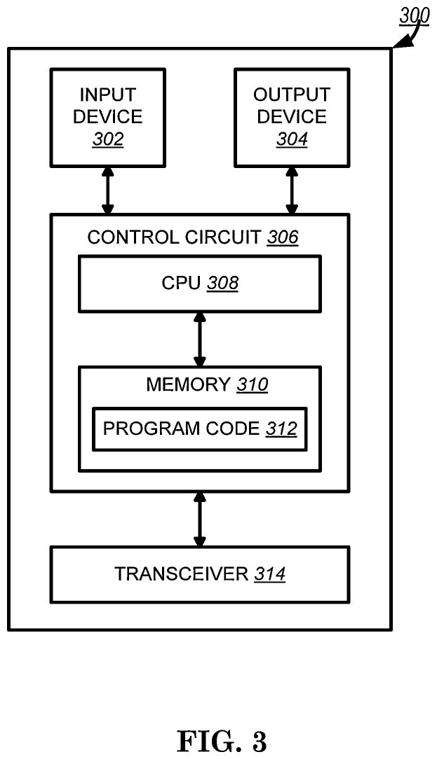

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

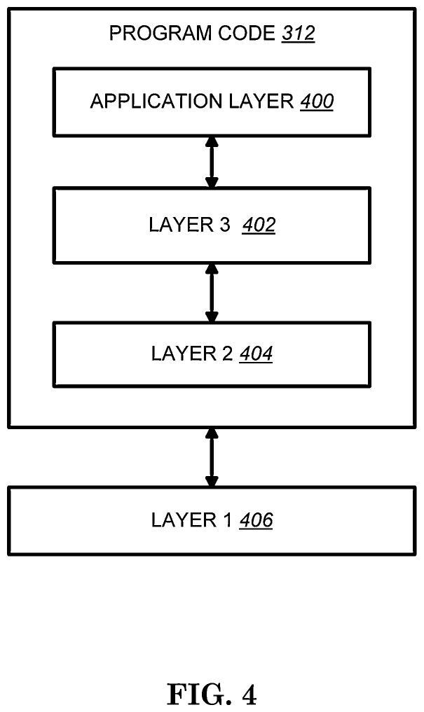

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP RP-201038 specifies the Justification and Objective of work item on NR multicast and broadcast services (MBS) as follows:

### 3 Justification

A discussion on 5G Broadcast evolution in RAN took place between RAN #78 and RAN #80, summarizing the technical attributes of “terrestrial broadcast” and “mixed mode multicast”, leading to a recommendation to proceed with a study on “terrestrial broadcast” in Rel-16, while leaving the standardization of “mixed mode” multicast/broadcast to further releases. The LTE Rel-16 WI on enhanced EN-TV was approved in RAN #83, targeting the introduction of new frame structures with new CPs and the related designs. The main attributes of “terrestrial broadcast” are broadcast only, DL-only, large and static transmission areas typically achieved with High-Power High-Tower deployments.

No broadcast/multicast feature support is specified in the first two NR releases, i.e. Rel-15 and Rel-16. Nevertheless, there are important use cases for which broadcast/multicast could provide substantial improvements, especially in regards to system efficiency and user experience.

A study item on the Architectural enhancements for 5G multicast-broadcast services has been approved in SP-190625 and it is ongoing.

Objective A of the SA2 SI is about Enabling general MBS services over 5GS and the uses cases identified that could benefit from this feature include (but are not limited to) public safety and mission critical, V2X applications, transparent IPv4/IPv6 multicast delivery, IPTV, software delivery over wireless, group communications and IoT applications.

This WI aims to provide the support in RAN for Objective A, consistently with TR 23.757. Support of Objective B (e.g. linear TV, Live, smart TV, and managed and OTT content, radio services) is not in scope of this WI, i.e. we should not design the RAN part of the system to fulfil Objective B, however it is possible that solutions designed for Objective A would enable efficient radio resource utilization for services supported in Objective B, and we aim for forward compatibility towards Objective B were possible.

In particular, for public safety and mission critical, we should take into account as much as possible design goals identified during the SA6 Study on enhanced Mission Critical (MC) services over 5G multicast-broadcast system (SP-190726) as captured in TR 23.774 and requirements identified by SA1 in TS22.261, clause 6.13.2, provided that the RAN system complexity is manageable.

### 4 Objective

### 4.1 Objective of SI or Core Part WI or Testing Part WI

The set of objectives includes:
Specify RAN basic functions for broadcast/multicast for UEs in RRC_CONNECTED state [RAN1, RAN2, RAN3]:
   Specify a group scheduling mechanism to allow UEs to receive Broadcast/Multicast service [RAN1, RAN2]
      This objective includes specifying necessary enhancements that are required to enable simultaneous operation with unicast reception.
   Specify support for dynamic change of Broadcast/Multicast service delivery between multicast (PTM) and unicast (PTP) with service continuity for a given UE [RAN2, RAN3]
   Specify support for basic mobility with service continuity [RAN2, RAN3]
   Assuming that the necessary coordination function (like functions hosted by MCE, if any) resides in the gNB-CU, specify required changes on the RAN architecture and interfaces, considering the results of the SA2 SI on Broadcast/Multicast (SP-190625) [RAN3]
   Specify required changes to improve reliability of Broadcast/Multicast service, e.g. by UL feedback. The level of reliability should be based on the requirements of the application/service provided.[RAN1, RAN2]
   Study the support for dynamic control of the Broadcast/Multicast transmission area within one gNB-DU and specify what is needed to enable it, if anything [RAN2, RAN3]
Specify RAN basic functions for broadcast/multicast for UEs in RRC_IDLE/RRC_INACTIVE states [RAN2, RAN1]:
   Specify required changes to enable the reception of Point to Multipoint transmissions by UEs in RRC_IDLE/RRC_INACTIVE states, with the aim of keeping maximum commonality between RRC_CONNECTED state and RRC_IDLE/RRC_INACTIVE state for the configuration of PTM reception. [RAN2, RAN1].
   Note: the possibility of receiving Point to Multipoint transmissions by UEs in RRC_IDLE/RRC_INACTIVE states, without the need for those UEs to get the configuration of the PTM bearer carrying the Broadcast/Multicast service while in RRC CONNECTED state beforehand, is subject to verification of service subscription and authorization assumptions during the WI.

The Chairman Notes for the 3GPP TSG RAN WG1 meeting #102-e states:

### Agreements:

For RRC_CONNECTED UEs, HARQ-ACK feedback is supported for multicast and no additional evaluation is needed to justify this.
[ . . . ]

### Agreements:

For RRC_CONNECTED UEs, at least support group-common PDCCH with CRC scrambled by a common RNTI to schedule a group-common PDSCH, where the scrambling of the group-common PDSCH is based on the same common RNTI.
   [ . . . ]

### Agreements:

For RRC_CONNECTED UEs, define/configure common frequency resource for group-common PDSCH.

### Agreements:

For RRC_CONNECTED UEs, at least support FDM between unicast PDSCH and group-common PDSCH in a slot based on UE capability.

The Chairman Notes for the 3GPP TSG RAN WG1 meeting #103-e states:

Agreements: For convenience of discussion, consider the following clarification as RAN1 common understanding.
PTP transmission: For RRC_CONNECTED UEs, use UE-specific PDCCH with CRC scrambled by UE-specific RNTI (e.g., C-RNTI) to schedule UE-specific PDSCH which is scrambled with the same UE-specific RNTI.
PTM transmission scheme 1: For RRC_CONNECTED UEs in the same MBS group, use group-common PDCCH with CRC scrambled by group-common RNTI to schedule group-common PDSCH which is scrambled with the same group-common RNTI. This scheme can also be called group-common PDCCH based group scheduling scheme.
PTM transmission scheme 2: For RRC_CONNECTED UEs in the same MBS group, use UE-specific PDCCH with CRC scrambled by UE-specific RNTI (e.g., C-RNTI) to schedule group-common PDSCH which is scrambled with group-common RNTI. This scheme can also be called UE-specific PDCCH based group scheduling scheme.
Note: The ‘UE-specific PDCCH/PDSCH’ here means the PDCCH/PDSCH can only be identified by the target UE but cannot be identified by the other UEs in the same MBS group with the target UE.
Note: The ‘group-common PDCCH/PDSCH’ here means the PDCCH/PDSCH are transmitted in the same time/frequency resources and can be identified by all the UEs in the same MBS group.
FFS whether or not to have additional definition of transmission scheme(s)
   Agreements: For RRC_CONNECTED UEs, if initial transmission for multicast is based on PTM transmission scheme 1, at least support retransmission(s) can use PTM transmission scheme 1.
   [ . . . ]

### Working Assumption:

For multicast of RRC-CONNECTED UEs, a common frequency resource for group-common PDCCH/PDSCH is confined within the frequency resource of a dedicated unicast BWP to support simultaneous reception of unicast and multicast in the same slot
Down select from the two options for the common frequency resource for group-common PDCCH/PDSCH
   Option 2A: The common frequency resource is defined as an MBS specific BWP, which is associated with the dedicated unicast BWP and using the same numerology (SCS and CP)
   [ . . . ]
      FFS BWP switching is needed between the multicast reception in the MBS specific BWP and unicast reception in its associated dedicated BWP
   Option 2B: The common frequency resource is defined as an ‘MBS frequency region’ with a number of contiguous PRBs, which is configured within the dedicated unicast BWP.
   [ . . . ]
      Agreements: Support TDM between one unicast PDSCH and one group-common PDSCH in a slot based on UE capability for RRC_CONNECTED UEs.
      Agreements: Support SPS group-common PDSCH for MBS for RRC_CONNECTED UEs
      [ . . . ]
      Agreements: For PTM transmission scheme 1, the CORESET for group-common PDCCH is configured within the common frequency resource for group-common PDSCH.
FFS: number of CORESET(s) for group-common PDCCH within the common frequency resource for group-common PDSCH
   Agreements: For search space set of group-common PDCCH of PTM scheme 1 for multicast in RRC_CONNECTED state, the CCE indexes are common for different UEs in the same MBS group.
   Agreements: Down select from the two options for BDs/CCEs limit for Rel-17 MBS
Option 1: the maximum number of monitored PDCCH candidates and non-overlapped CCEs per slot per serving cell defined in Rel-15 is kept unchanged for Rel-17 MBS.
Option 2: For UEs supporting CA capability, the budget of BDs/CCEs of an unused CC can be used for group-common PDCCH to count the number of BDs/CCEs, which is similar to the method used for multi-DCI based multi-TRP in Rel-16.
   Agreements: For RRC_CONNECTED UEs, support inter-slot TDM between unicast PDSCH and group-common PDSCH in different slots (mandatory for the UE supporting MBS).
   Agreements: Further study the following cases for simultaneous reception of unicast PDSCH and group-common PDSCH in a slot based on UE capability for RRC_CONNECTED UEs.
Case 1: support TDM between multiple TDMed unicast PDSCHs and one group-common PDSCH in a slot
Case 2: support TDM among multiple group-common PDSCHs in a slot
Case 3: support TDM between multiple TDMed unicast PDSCHs and multiple TDMed group-common PDSCHs in a slot
Case 4: support FDM between multiple TDMed unicast PDSCHs and multiple TDMed group-common PDSCHs in a slot
Case 5: support FDM among multiple group-common PDSCHs in a slot
FFS: maximum number of PDSCHs in a slot simultaneous received per UE
   Agreements: For search space set of group-common PDCCH of PTM scheme 1 for multicast in RRC_CONNECTED state, further study the following options.
Option 1: Define a new search space type specific for multicast
Option 2: Reuse the existing CSS type(s) in Rel-15/16
   FFS: whether modifications are needed for multicast
Option 3: Reuse the existing USS in Rel-15/16 with necessary modifications for MBS
   FFS: detailed modifications
      Agreements: No specification enhancement in Rel-17 to support SDM between unicast PDSCH and group-common PDSCH in a slot for RRC_CONNECTED UEs.
      Agreements: For PTM transmission scheme 1, if Option 2A or Option 2B for common frequency resource for group-common PDCCH/PDSCH is agreed, the FDRA field of group-common PDCCH is interpreted based on the common frequency resource.
      Agreements: For search space set of group-common PDCCH of PTM scheme 1 for multicast in RRC_CONNECTED state, further study the following options for the monitoring priority of search space set
Option 1: The monitoring priority of search space set for multicast is the same as existing Rel-15/16 CSS
Option 2: The monitoring priority of search space set for multicast is the same as existing Rel-15/16 USS
Other options are not precluded
The monitoring priority is used at least for PDCCH overbooking case
   FFS for other cases (e.g., to prune PDCCH in terms of whether it's unicast or multicast, etc.)

### Agreements:

For RRC_CONNECTED UEs receiving multicast, at least for PTM scheme 1, support at least one of the following:
ACK/NACK based HARQ-ACK feedback for multicast,
   From per UE perspective, UE feedback ACK or NACK.
   From UEs within the group perspective,
      FFS: PUCCH resource configuration for ACK/NACK feedback e.g., shared or separate PUCCH resources.
   FFS details including conditions for it to be used
NACK-only based HARQ-ACK feedback for multicast,
   From per UE perspective, UE only feedback NACK.
   From UEs within the group perspective
      FFS: PUCCH resource configuration for NACK only feedback.
   FFS details including conditions for it to be used
To decide in RAN1 #104-e whether or not to support only one or both of the above schemes
   If both are supported, FFS configuration/selection of ACK/NACK-based and NACK-only based HARQ-ACK feedback

### Agreements:

For RRC_CONNECTED UEs receiving multicast, for ACK/NACK based HARQ-ACK feedback if supported for group-common PDCCH scheduling, PUCCH resource configuration for HARQ-ACK feedback from per UE perspective is, down-select one of the following options:
Option 1: shared with PUCCH resource configuration for HARQ-ACK feedback for unicast
Option 2: separate from PUCCH resource configuration for HARQ-ACK feedback for unicast
Option 3: Option 1 or option 2 based on configuration

### Agreements:

For RRC_CONNECTED UEs receiving multicast, for NACK-only based HARQ-ACK feedback if supported for group-common PDCCH scheduling, PUCCH resource configuration for HARQ-ACK feedback from per UE perspective is separate from PUCCH resource configuration for HARQ-ACK feedback for unicast.
FFS PUCCH format

### Agreements:

Enabling/disabling HARQ-ACK feedback for MBS is supported, further down-select between:
Option 1: DCI
Option 2: RRC configures enabling/disabling
Option 3: RRC configures the enabling/disabling function and DCI indicates enabling/disabling
FFS: Option 4: MAC-CE indicates enabling/disabling
FFS: Option 5: RRC configures the enabling/disabling function and MAC-CE indicates enabling/disabling

### Agreements:

For slot-level repetition for group-common PDSCH of RRC_CONNECTED UEs, for indicating the repetition number, further down-select among:
Opt 1: by DCI
Opt 2: by RRC
Opt 3: by RRC+DCI
FFS: Opt 4: by MAC-CE
FFS: Opt 5: by RRC+MAC-CE
FFS details for each option.
FFS further enhancements for configuration of slot-level repetition

### Agreements:

From the perspective of RRC_CONNECTED UEs receiving multicast, at least for PTM scheme 1 initial transmission, retransmission supports, for the purpose of down-selection, options are:
Option 1: group-common PDCCH scheduled group-common PDSCH
Option 2: UE-specific PDCCH scheduled PDSCH
   Alt 1: PDSCH is UE-specific PDSCH
   Alt 2: PDSCH is group-common PDSCH
Option 3: both option 1 and option 2
FFS other options
FFS CBG based retransmission
   [ . . . ]

### Agreements:

For ACK/NACK based HARQ-ACK feedback if supported, both Type-1 and Type-2 HARQ-ACK codebook are supported for RRC_CONNECTED UEs receiving multicast,
FFS details of HARQ-ACK codebook design.
FFS whether enhanced Type-2 and/or Type-3 HARQ-ACK codebook is supported or not.

The Chairman Notes for the 3GPP TSG RAN WG1 meeting #104-e states:

### Agreement:

For multicast of RRC-CONNECTED UEs, a common frequency resource for group-common PDCCH/PDSCH is confined within the frequency resource of a dedicated unicast BWP to support simultaneous reception of unicast and multicast in the same slot
Down select from the two options for the common frequency resource for group-common PDCCH/PDSCH
   Option 2A: The common frequency resource is defined as an MBS specific BWP, which is associated with the dedicated unicast BWP and using the same numerology (SCS and CP)
   [ . . . ]
   Option 2B: The common frequency resource is defined as an ‘MBS frequency region’ with a number of contiguous PRBs, which is configured within the dedicated unicast BWP.
   [ . . . ]

### Agreement:

If Option 2B is supported for common frequency resource for multicast of RRC-CONNECTED UEs, the starting PRB and the length of PRBs of the MBS frequency region within a dedicated unicast BWP are configured via UE-specific RRC signaling.
   The starting PRB is referenced to one of the two options:
      Option 1: Point A
      Option 2: the starting PRB of the dedicated unicast BWP
   FFS the detailed signaling
If Option 2A is supported for common frequency resource for multicast of RRC-CONNECTED UEs, the configurations of the starting PRB and the length of PRBs of the MBS frequency resource reuse the legacy BWP configuration.

### Agreement:

For RRC_CONNECTED UEs, if ACK/NACK based HARQ-ACK feedback is supported for PTM scheme 1, and if initial transmission for multicast is based on PTM transmission scheme 1, support retransmission(s) using PTP transmission.
The HARQ process ID and NDI indicated in DCI is used to associate the PTM scheme 1 and PTP transmitting the same TB.

### Agreement:

The maximum number of monitored PDCCH candidates and non-overlapped CCEs per slot per serving cell defined in Rel-15 is kept unchanged for Rel-17 MBS.
FFS whether the budget of BDs/CCEs of an unused CC can be used for group-common PDCCH to count the number of BDs/CCEs for UEs supporting CA capability based on configuration, which is similar to the method used for multi-DCI based multi-TRP in Rel-16.

### Working Assumption:

Keep the “3+1” DCI size budget defined in Rel-15 for Rel-17 MBS.
FFS: Whether the G-RNTI is counted as “C-RNTI” or as “other RNTI” when considering the “3+1” DCI size budget rule for group-common PDCCH.

### Agreement:

For RRC_CONNECTED UEs, more than one SPS group-common PDSCH configuration for MBS can be configured per UE subject to UE capability
The total number of SPS configurations supported by a UE currently defined for unicast is not increased due to additionally supporting MBS.
FFS: How to allocate the total SPS configurations between MBS and unicast.

### Agreement:

For RRC_CONNECTED UEs, support HARQ-ACK feedback for SPS group-common PDSCH for MBS
FFS: The retransmission scheme(s)
FFS: The HARQ-ACK details for SPS PDSCH and activation/deactivation, which can be discussed in AI 8.12.2

### Agreement:

From RAN1 perspective, the CFR (common frequency resource) for multicast of RRC-CONNECTED UEs, which is confined within the frequency resource of a dedicated unicast BWP and using the same numerology (SCS and CP), includes the following configurations:
Starting PRB and the number of PRBs
One PDSCH-config for MBS (i.e., separate from the PDSCH-Config of the dedicated unicast BWP)
One PDCCH-config for MBS (i.e., separate from the PDCCH-Config of the dedicated unicast BWP)
SPS-config(s) for MBS (i.e., separate from the SPS-Config of the dedicated unicast BWP)
FFS: Other configurations and details including whether signaling of starting PRB and the length of PRBs is needed when CFR is equal to the unicast BWP
FFS: Whether a unified CFR design is also used for broadcast reception for RRC_IDLE/INACTIVE and RRC_CONNECTED
FFS: Whether Coreset(s) for CFR in addition to existing Coresets in UE dedicated BWP is needed
Note: The terminology of CFR is only aiming for RAN1 discussion, and the detailed signaling design is up to RAN2
Note: This agreement does not negate any previous agreements made on CFR

### Agreement:

For search space set of group-common PDCCH of PTM scheme 1 for multicast in RRC_CONNECTED state, at least support CSS
FFS: reuse existing CSS type(s) in Rel-15/16 or define a new Type CSS
FFS: Two options for monitoring priority:
   Option 1: the monitoring priority is the same as existing Rel-15/16 CSS
   Option 2: the monitoring priority is determined based on the search space set indexes of search space set(s) for multicast and USS sets.

### Working Assumption:

For activation/deactivation of SPS group-common PDSCH for MBS in RRC_CONNECTED state,
At least group-common PDCCH is supported
   FFS: Whether and how to address the missed activation and deactivation
FFS: Whether UE-specific PDCCH is supported for activation/deactivation

### Agreement:

For ACK/NACK based feedback if supported for RRC_CONNECTED UEs receiving multicast, UE can be optionally configured a separate PUCCH-Config for multicast. Otherwise, PUCCH-Config for unicast applies.

### Agreement:

The priority for HARQ-ACK feedback for RRC_CONNECTED UE receiving multicast can be,
Lower, higher than or equal to the HARQ-ACK feedback for unicast
   FFS: How to reflect the priority in specification, e.g., whether it is configured or indicated to the UE
   FFS: The total number of priorities across multicast and unicast
FFS the priority between HARQ-ACK feedback for multicast and other UCI for unicast (SR, CSI) or PUSCH for unicast.

### Agreement:

For ACK/NACK based feedback if supported for multicast, for Type-2 HARQ-ACK feedback construction for PTM scheme 1,
DAI for unicast and DAI for multicast are separately counted.
Concatenation of Type-2 HARQ-ACK codebook for unicast and multicast is supported.
   FFS details on concatenating the codebooks.
FFS whether to support concatenating more than one Type-2 HARQ-ACK codebook for multicast.

### Agreement:

For RRC_CONNECTED UEs receiving multicast, support the following:
ACK/NACK based HARQ-ACK feedback for multicast,
   It is up to network to configure orthogonal PUCCH resources among UEs within the same group.
FFS: NACK-only based HARQ-ACK feedback for multicast,
   It is up to network to configure the PUCCH resources and the PUCCH resources can be shared among UEs within the same group.
FFS details.

### Agreement:

For the cases of HARQ-ACK feedback (at least for ACK/NACK based feedback) is available for multicast and unicast for a given UE receiving multicast, for determining the PUCCH resource,
Support multiplexing for the same priority and prioritizing for different priorities at least when the corresponding PUCCH resources overlap in time in a slot.
   FFS whether it is subject to UE capability.
FFS the case of non-overlapping PUCCHs resources for HARQ-ACK in the same slot.
FFS whether sub-slot based PUCCH transmission for HARQ-ACK is supported.
FFS the case of HARQ-ACK feedback for multicast and other UCI for unicast.

### Agreement:

For ACK/NACK based feedback if supported for multicast, construction of Type-1 HARQ-ACK codebook based on the union of the PDSCH TDRA sets of the unicast service and the multicast service (if they are separately configured), at least of the same priority, is supported
FFS details of Type-1 HARQ-ACK codebook construction for FDM-ed unicast and multicast.
FFS details of Type-1 HARQ-ACK codebook construction for FDM-ed multicast and multicast if supported.
FFS: whether/how to optimize the Type-1 codebook construction to reduce the HARQ-ACK feedback payload size.

### Agreement:

For enabling/disabling HARQ-ACK feedback for RRC_CONNECTED UE receiving multicast,
Option 3: RRC signalling configures the enabling/disabling function of DCI indicating the enabling/disabling HARQ-ACK feedback.
   If RRC signalling configures the function, DCI indicates (explicitly or implicitly) whether HARQ-ACK feedback is enabled/disabled
      FFS details on RRC signalling and DCI indicating.
   If RRC signalling does not configure the function, DCI does not indicate enabling/disabling the HARQ-ACK feedback.
      FFS whether enabling or disabling the feedback is the default mode.
Option 2: RRC indicates enabling/disabling.
FFS: whether down-selection between option 3 and option 2 is needed or support the both options.
FFS: enabling/disabling by MAC-CE.

### Agreement:

For slot-level repetition for group-common PDSCH for RRC_CONNECTED UEs receiving multicast,
(Config A) UE can be optionally configured with pdsch-AggregationFactor.
(Config B) UE can be optionally configured with TDRA table with repetitionNumber as part of the TDRA table.
If UE is configured with Config B, UE does not expect to be configured with Config A for the same group-common PDSCH.

3GPP TS 38.212 states:

### 7.3.1 DCI Formats

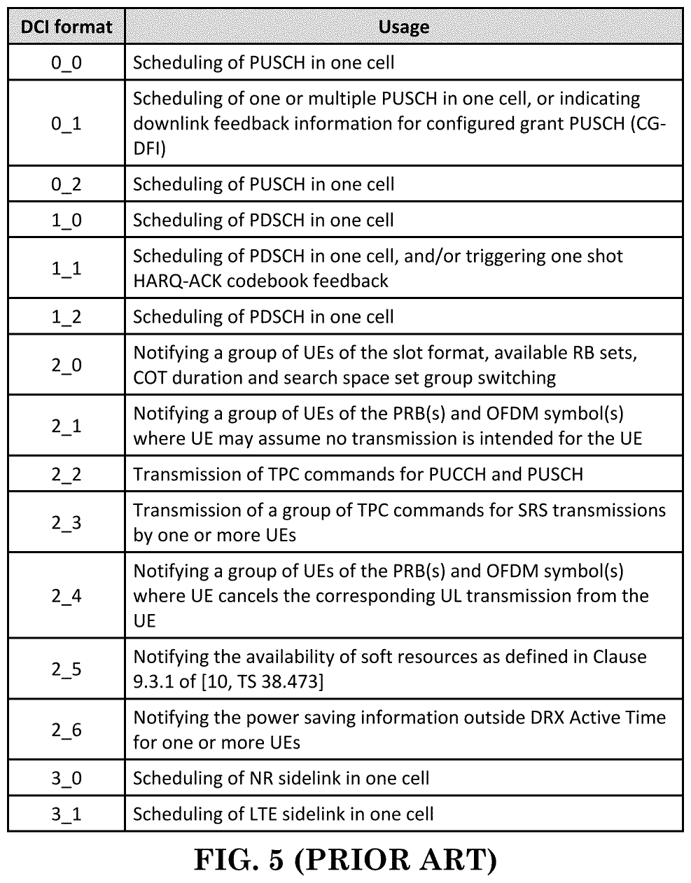

The DCI formats defined in table 7.3.1-1 are supported.

[Table 7.3.1-1 of 3GPP TS 38.212 V16.4.0, entitled “DCI formats”, is reproduced as FIG. 5]

[ . . . ]

### Format 1_0

DCI format 1_0 is used for the scheduling of PDSCH in one DL cell.
The following information is transmitted by means of the DCI format 1_0 with CRC scrambled by C-RNTI or CS-RNTI or MCS-C-RNTI:
Identifier for DCI formats—1 bits
   The value of this bit field is always set to 1, indicating a DL DCI format
Frequency domain resource assignment—┌log₂(N_{RB}^{DL,BWP}(N_{RB}^{DL,BWP}+1)/2)┐ bits where NP_{RB}^{DL,BWP} is given by clause 7.3.1.0
[ . . . ]
Time domain resource assignment—4 bits as defined in Clause 5.1.2.1 of [6, TS 38.214]
VRB-to-PRB mapping—1 bit according to Table 7.3.1.2.2-5
Modulation and coding scheme—5 bits as defined in Clause 5.1.3 of [6, TS 38.214]
New data indicator—1 bit
Redundancy version—2 bits as defined in Table 7.3.1.1.1-2
HARQ process number—4 bits
Downlink assignment index—2 bits as defined in Clause 9.1.3 of [5, TS 38.213], as counter DAI
TPC command for scheduled PUCCH—2 bits as defined in Clause 7.2.1 of [5, TS 38.213]
PUCCH resource indicator—3 bits as defined in Clause 9.2.3 of [5, TS 38.213]
PDSCH-to-HARQ_feedback timing indicator—3 bits as defined in Clause 9.2.3 of [5, TS38.213]
ChannelAccess-CPext—2 bits indicating combinations of channel access type and CP extension as defined in Table 7.3.1.1.1-4 for operation in a cell with shared spectrum channel access; 0 bits otherwise
   [ . . . ]

### Format 1_1

DCI format 1_1 is used for the scheduling of PDSCH in one cell.
The following information is transmitted by means of the DCI format 1_1 with CRC scrambled by C-RNTI or CS-RNTI or MCS-C-RNTI:
Identifier for DCI formats—1 bits
   The value of this bit field is always set to 1, indicating a DL DCI format
Carrier indicator—0 or 3 bits as defined in Clause 10.1 of [5, TS 38.213].
Bandwidth part indicator—0, 1 or 2 bits as determined by the number of DL BWPs n_{BWP,RRC} configured by higher layers, excluding the initial DL bandwidth part. The bitwidth for this field is determined as ┌log₂(n_{BWP})┐ bits, where
   n_{BWP}=n_{BWP,RRC}+1 if n_{BWP,RRC}≤3, in which case the bandwidth part indicator is equivalent to the ascending order of the higher layer parameter BWP-Id;
   otherwise n_{BWP}=n_{BWP,RRC}, in which case the bandwidth part indicator is defined in Table 7.3.1.1.2-1;
If a UE does not support active BWP change via DCI, the UE ignores this bit field.
Frequency domain resource assignment—number of bits determined by the following, where N_{RB}^{DL,BWP} is the size of the active DL bandwidth part:
   N_{RBG} bits if only resource allocation type 0 is configured, where N_{RBG} is defined in Clause 5.1.2.2.1 of [6, TS38.214],
   ┌log₂(N_{RB}^{DL,BWP}(N_{RB}^{DL,BWP}+1)/2)┐ bits if only resource allocation type 1 is configured, or
   max (┌log₂ (N_{RB}^{DL,BWP} (N_{RB}^{DL,BWP}+1)/2)┐, N_{RBG})+1 bits if resourceAllocation is configured as ‘dynamicSwitch’.
   If resourceAllocation is configured as ‘dynamicSwitch’, the MSB bit is used to indicate resource allocation type 0 or resource allocation type 1, where the bit value of 0 indicates resource allocation type 0 and the bit value of 1 indicates resource allocation type 1.
   For resource allocation type 0, the N_{RBG} LSBs provide the resource allocation as defined in Clause 5.1.2.2.1 of [6, TS 38.214].
   For resource allocation type 1, the ┌log₂(N_{RB}^{DL,BWP}(N_{RB}^{DL,BWP}+1)/2)┐ LSBs provide the resource allocation as defined in Clause 5.1.2.2.2 of [6, TS 38.214]
If “Bandwidth part indicator” field indicates a bandwidth part other than the active bandwidth part and if resourceAllocation is configured as ‘dynamicSwitch’ for the indicated bandwidth part, the UE assumes resource allocation type 0 for the indicated bandwidth part if the bitwidth of the “Frequency domain resource assignment” field of the active bandwidth part is smaller than the bitwidth of the “Frequency domain resource assignment” field of the indicated bandwidth part.
Time domain resource assignment—0, 1, 2, 3, or 4 bits as defined in Clause 5.1.2.1 of [6, TS 38.214]. The bitwidth for this field is determined as ┌log₂(I)┐ bits, where/is the number of entries in the higher layer parameter pdsch-TimeDomainAllocationList if the higher layer parameter is configured; otherwise/is the number of entries in the default table.
[ . . . ]

3GPP TS 38.213 states:

### 10.2 PDCCH Validation for DL SPS and UL Grant Type 2

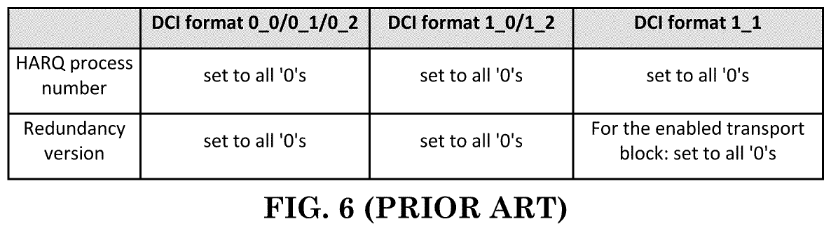

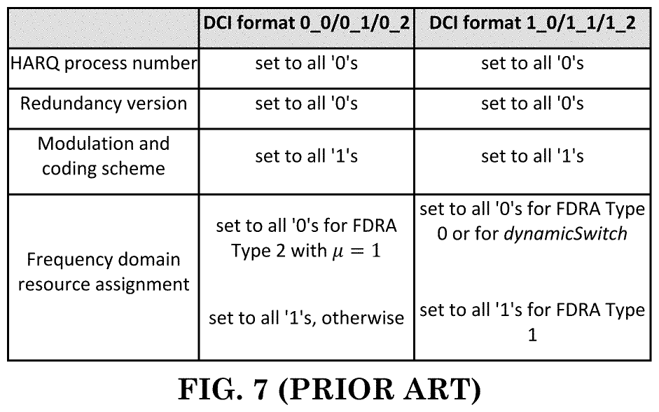

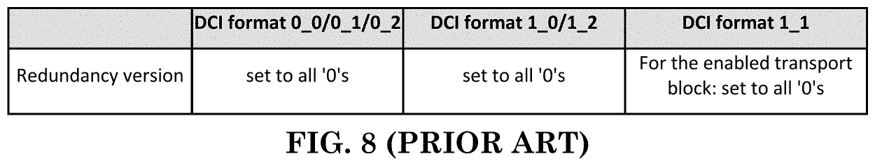

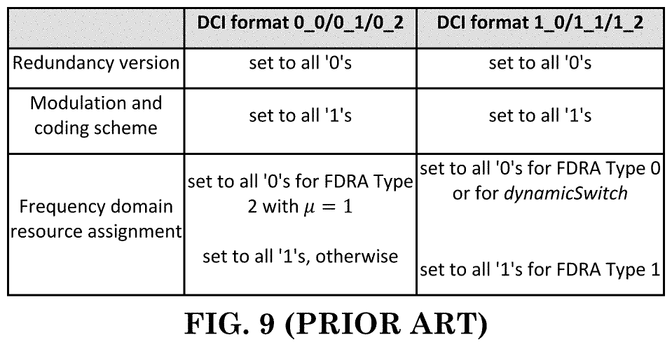

A UE validates, for scheduling activation or scheduling release, a DL SPS assignment PDCCH or a configured UL grant Type 2 PDCCH if
the CRC of a corresponding DCI format is scrambled with a CS-RNTI provided by cs-RNTI, and
the new data indicator field in the DCI format for the enabled transport block is set to ‘0’, and
the DFI flag field, if present, in the DCI format is set to ‘0’, and
if validation is for scheduling activation and if the PDSCH-to-HARQ_feedback timing indicator field in the DCI format is present, the PDSCH-to-HARQ_feedback timing indicator field does not provide an inapplicable value from dl-DataToUL-ACK-r16.
   If a UE is provided a single configuration for UL grant Type 2 PUSCH or for SPS PDSCH, validation of the DCI format is achieved if all fields for the DCI format are set according to Table 10.2-1 or Table 10.2-2.
   If a UE is provided more than one configurations for UL grant Type 2 PUSCH or for SPS PDSCH, a value of the HARQ process number field in a DCI format indicates an activation for a corresponding UL grant Type 2 PUSCH or for a SPS PDSCH configuration with a same value as provided by ConfiguredGrantConfigIndex or by sps-ConfigIndex, respectively. Validation of the DCI format is achieved if the RV field for the DCI format is set as in Table 10.2-3.
   If a UE is provided more than one configuration for UL grant Type 2 PUSCH or for SPS PDSCH
if the UE is provided ConfiguredGrantConfigType2DeactivationStateList or sps-ConfigDeactivationStateList, a value of the HARQ process number field in a DCI format indicates a corresponding entry for scheduling release of one or more UL grant Type 2 PUSCH or SPS PDSCH configurations
if the UE is not provided ConfiguredGrantConfigType2DeactivationStateList or sps-ConfigDeactivationStateList, a value of the HARQ process number field in a DCI format indicates a release for a corresponding UL grant Type 2 PUSCH or for a SPS PDSCH configuration with a same value as provided by ConfiguredGrantConfigIndex or by sps-ConfigIndex, respectively
   Validation of the DCI format is achieved if all fields for the DCI format are set according to Table 10.2-4.
   If validation is achieved, the UE considers the information in the DCI format as a valid activation or valid release of DL SPS or configured UL grant Type 2. If validation is not achieved, the UE discards all the information in the DCI format.
[Table 10.2-1 of 3GPP TS 38.213 V16.4.0, entitled “Special fields for single DL SPS or single UL grant Type 2 scheduling activation PDCCH validation when a UE is provided a single SPS PDSCH or UL grant Type 2 configuration in the active DL/UL BWP of the scheduled cell”, is reproduced as FIG. 6]
[Table 10.2-2 of 3GPP TS 38.213 V16.4.0, entitled “Special fields for single DL SPS or single UL grant Type 2 scheduling release PDCCH validation when a UE is provided a single SPS PDSCH or UL grant Type 2 configuration in the active DL/UL BWP of the scheduled cell”, is reproduced as FIG. 7]
[Table 10.2-3 of 3GPP TS 38.213 V16.4.0, entitled “Special fields for a single DL SPS or single UL grant Type 2 scheduling activation PDCCH validation when a UE is provided multiple DL SPS or UL grant Type 2 configurations in the active DL/UL BWP of the scheduled cell”, is reproduced as FIG. 8]
[Table 10.2-4 of 3GPP TS 38.213 V16.4.0, entitled “Special fields for a single or multiple DL SPS and UL grant Type 2 scheduling release PDCCH validation when a UE is provided multiple DL SPS or UL grant Type 2 configurations in the active DL/UL BWP of the scheduled cell”, is reproduced as FIG. 9]
   A UE is expected to provide HARQ-ACK information in response to a SPS PDSCH release after N symbols from the last symbol of a PDCCH providing the SPS PDSCH release. If processingType2Enabled of PDSCH-ServingCellConfig is set to enable for the serving cell with the PDCCH providing the SPS PDSCH release, N=5 for μ=0, N=5.5 for μ=1, and N=11 for μ=2, otherwise, N=10 for μ=0, N=12 for μ=1, N=22 for μ=2, and N=25 for μ=3, wherein y corresponds to the smallest SCS configuration between the SCS configuration of the PDCCH providing the SPS PDSCH release and the SCS configuration of a PUCCH carrying the HARQ-ACK information in response to a SPS PDSCH release.

3GPP TS 38.331 states:

If more than one PDSCH on a serving cell each without a corresponding PDCCH transmission are in a slot, after resolving overlapping with symbols in the slot indicated as uplink by tdd-UL-DL-ConfigurationCommon, or by tdd-UL-DL-ConfigurationDedicated, a UE receives one or more PDSCHs without corresponding PDCCH transmissions in the slot as specified below.
Step 0: set j=0, where j is the number of selected PDSCH(s) for decoding. Q is the set of activated PDSCHs without corresponding PDCCH transmissions within the slot
Step 1: A UE receives one PDSCH with the lowest configured sps-ConfigIndex within Q, set j=j+1. Designate the received PDSCH as survivor PDSCH.
Step 2: The survivor PDSCH in step 1 and any other PDSCH(s) overlapping (even partially) with the survivor PDSCH in step 1 are excluded from Q.
Step 3: Repeat step 1 and 2 until Q is empty or j is equal to the number of unicast PDSCHs in a slot supported by the UE

3GPP TS 38.214 states:
BWP-DownlinkDedicated
   The IE BWP-DownlinkDedicated is used to configure the dedicated (UE specific) parameters of a downlink BWP.

BWP-DownlinkDedicated information element

-- ASN1START
-- TAG-BWP-DOWNLINKDEDICATED-START
BWP-DownlinkDedicated ::= SEQUENCE {

| | |
|---|---|
| pdcch-Config | SetupRelease { PDCCH-Config } |

OPTIONAL, -- Need M

| | |
|---|---|
| pdsch-Config | SetupRelease { PDSCH-Config } |

OPTIONAL, -- Need M

| | |
|---|---|
| sps-Config | SetupRelease { SPS-Config } |

OPTIONAL, -- Need M

| | |
|---|---|
| radioLinkMonitoringConfig | SetupRelease { RadioLinkMonitoringConfig } |

```
OPTIONAL,  -- Need M
  ...,
  [[
```

| | |
|---|---|
| sps-ConfigToAddModList-r16 | SPS-ConfigToAddModList-r16 |

OPTIONAL, -- Need N

| | |
|---|---|
| sps-ConfigToReleaseList-r16 | SPS-ConfigToReleaseList-r16 |

OPTIONAL, -- Need N

| | |
|---|---|
| sps-ConfigDeactivationStateList-r16 | SPS-ConfigDeactivationStateList-r16 |

OPTIONAL, -- Need R

| | |
|---|---|
| beamFailureRecoverySCellConfig-r16 | SetupRelease {BeamFailureRecoverySCellConfig-r16} |

OPTIONAL, -- Cond SCellOnly

| | |
|---|---|
| sl-PDCCH-Config-r16 | SetupRelease { PDCCH-Config } |

OPTIONAL, -- Need M

| | |
|---|---|
| sl-V2X-PDCCH-Config-r16 | SetupRelease { PDCCH-Config } |

OPTIONAL, -- Need M
]]
}

| | |
|---|---|
| SPS-ConfigToAddModList-r16 ::= | SEQUENCE (SIZE (1..maxNrofSPS-Config-r16)) OF SPS-Config |
| SPS-ConfigToReleaseList-r16 ::= | SEQUENCE (SIZE (1..maxNrofSPS-Config-r16)) OF SPS- |

ConfigIndex-r16

| | |
|---|---|
| SPS-ConfigDeactivationState-r16 ::= | SEQUENCE (SIZE (1..maxNrofSPS-Config-r16)) OF SPS- |

ConfigIndex-r16

| | |
|---|---|
| SPS-ConfigDeactivationStateList-r16 ::= | SEQUENCE (SIZE (1..maxNrofSPS-DeactivationState)) OF SPS- |

ConfigDeactivationState-r16
-- TAG-BWP-DOWNLINKDEDICATED-STOP
-- ASN1STOP

BWP-DownlinkDedicated field descriptions

[ . . . ]
pdcch-Config
UE specific PDCCH configuration for one BWP.
pdsch-Config
UE specific PDSCH configuration for one BWP.
sps-Config
UE specific SPS (Semi-Persistent Scheduling) configuration for one BWP. Except for
reconfiguration with sync, the NW does not reconfigure sps-Config when there is an active
configured downlink assignment (see TS 38.321 [3]). However, the NW may release the sps-
Config at any time. Network can only configure SPS in one BWP using either this field or sps-
ConfigToAddModList.
sps-ConfigDeactivationStateList
Indicates a list of the deactivation states in which each state can be mapped to a single or
multiple SPS configurations to be deactivated, see clause 10.2 in TS 38.213 [13]. If a state is
mapped to multiple SPS configurations, each of these SPS configurations is configured with
the same harq-CodebookID.
sps-ConfigToAddModList
Indicates a list of one or more DL SPS configurations to be added or modified in one BWP.
Except for reconfiguration with sync, the NW does not reconfigure a SPS configuration when
it is active (see TS 38.321 [3]).
sps-ConfigToReleaseList
Indicates a list of one or more DL SPS configurations to be released. The NW may release a
SPS configuration at anytime.

| Conditional Presence | Explanation |
|---|---|
| ScellOnly | The field is optionally present, Need M, in the BWP- |
| | DownlinkDedicated of an Scell. It is absent otherwise. |

SPS-Config

The IE SPS-Config is used to configure downlink semi-persistent transmission. Multiple Downlink SPS configurations may be configured in one BWP of a serving cell.

SPS-Config information element

-- ASN1START
-- TAG-SPS-CONFIG-START
SPS-Config ::= SEQUENCE {

| | |
|---|---|
| periodicity | ENUMERATED {ms10, ms20, ms32, ms40, ms64, ms80, ms128, ms160, |

ms320, ms640,

spare6, spare5, spare4, spare3, spare2,

spare1},

| | |
|---|---|
| nrofHARQ-Processes | INTEGER (1..8), |
| n1PUCCH-AN | PUCCH-ResourceId |

OPTIONAL, -- Need M

| | |
|---|---|
| mcs-Table | ENUMERATED, {qam64LowSE} |

```
OPTIONAL,  -- Need S
  ...,
  [[
```

| | |
|---|---|
| sps-ConfigIndex-r16 | SPS-ConfigIndex-r16 |

OPTIONAL, -- Cond SPS-List

| | |
|---|---|
| harq-ProcID-Offset-r16 | INTEGER (0..15) |

OPTIONAL, -- Need R

| | |
|---|---|
| periodicityExt-r16 | INTEGER (1..5120) |

OPTIONAL, -- Need R

| | |
|---|---|
| harq-CodebookID-r16 | INTEGER (1..2) |

OPTIONAL, -- Need R

| | |
|---|---|
| pdsch-AggregationFactor-r16 | ENUMERATED {n1, n2, n4, n8 } |

OPTIONAL, -- Need M
]]
}
-- TAG-SPS-CONFIG-STOP
-- ASN1STOP

SPS-Config field descriptions

harq-CodebookID
Indicates the HARQ-ACK codebook index for the corresponding HARQ-ACK codebook for SPS
PDSCH and ACK for SPS PDSCH release.
harq-ProcID-Offset
Indicates the offset used in deriving the HARQ process IDs, see TS 38.321 [3], clause 5.3.1.
mcs-Table
Indicates the MCS table the UE shall use for DL SPS (see TS 38.214 [19], clause 5.1.3.1. If
present, the UE shall use the MCS table of low-SE 64QAM table indicated in Table 5.1.3.1-3 of
TS 38.214 [19]. If this field is absent and field mcs-table in PDSCH-Config is set to ‘qam256’
and the activating DCI is of format 1_1, the UE applies the 256QAM table indicated in Table
5.1.3.1-2 of TS 38.214 [19]. Otherwise, the UE applies the non-low-SE 64QAM table indicated
in Table 5.1.3.1-1 of TS 38.214 [19].
n1PUCCH-AN
HARQ resource for PUCCH for DL SPS. The network configures the resource either as format0
or format1. The actual PUCCH-Resource is configured in PUCCH-Config and referred to by its
ID. See TS 38.213 [13], clause 9.2.3.
nrofHARQ-Processes
Number of configured HARQ processes for SPS DL (see TS 38.321 [3], clause 5.8.1).
pdsch-AggregationFactor
Number of repetitions for SPS PDSCH (see TS 38.214 [19], clause 5.1.2.1). When the field is
absent, the UE applies PDSCH aggregation factor of PDSCH-Config.
periodicity
Periodicity for DL SPS (see TS 38.214 [19] and TS 38.321 [3], clause 5.8.1).
periodicityExt
This field is used to calculate the periodicity for DL SPS (see TS 38.214 [19] and see TS 38.321
[3], clause 5, 8.1). If this field is present, the field periodicity is ignored.
The following periodicities are supported depending on the configured subcarrier spacing
[ms]:
15 kHz: periodicityExt, where periodicityExt has a value between 1 and 640.
30 kHz: 0.5 × periodicityExt, where periodicityExt has a value between 1 and
1280.
60 kHz with normal CP. 0.25 × periodicityExt, where periodicityExt has a value between 1
and 2560.
60 kHz with ECP: 0.25 × periodicityExt, where periodicityExt has a value between 1 and
2560.
120 kHz: 0.125 × periodicityExt, where periodicityExt has a value between 1 and
5120.
sps-ConfigIndex
Indicates the index of one of multiple SPS configurations.

| Conditional Presence | Explanation |
|---|---|
| SPS-List | The field is mandatory present when included in sps- |
| | ConfigToAddModList-r16, otherwise the field is absent. |

SPS-ConfigIndex

The IE SPS-ConfigIndex is used to indicate the index of one of multiple DL SPS configurations in one BWP.

SPS-ConfigIndex information element

-- ASN1START
-- TAG-SPS-CONFIGINDEX-START
SPS-ConfigIndex-r16 ::= INTEGER (0.. maxNrofSPS-Config-r16-1)
-- TAG-SPS-CONFIGINDEX-STOP
-- ASN1STOP

FeatureSetDownlink

The IE FeatureSetDownlink indicates a set of features that the UE supports on the carriers corresponding to one band entry in a band combination.

FeatureSetDownlink information element

-- ASN1START
-- TAG-FEATURESETDOWNLINK-START
FeatureSetDownlink ::= SEQUENCE {

| | |
|---|---|
| featureSetListPerDownlinkCC | SEQUENCE (SITE (1..maxNrofServingCells)) OF |

FeatureSetDownlinkPerCC-Id,

| | |
|---|---|
| intraBandFreqSeparationDL | FreqSeparationClass |

OPTIONAL,

| | |
|---|---|
| scalingFactor | ENUMERATED {f0p4, f0p75, f0p8} |

OPTIONAL,

| | |
|---|---|
| dummy8 | ENUMERATED {supported} |

OPTIONAL,

| | |
|---|---|
| scellWithoutSSB | ENUMERATED {supported} |

OPTIONAL,

| | |
|---|---|
| csi-RS-MeasSCellWithoutSSB | ENUMERATED {supported} |

OPTIONAL,

| | |
|---|---|
| dummy1 | ENUMERATED {supported} |

OPTIONAL,

| | |
|---|---|
| type1-3-CSS | ENUMERATED {supported} |

OPTIONAL,

| | |
|---|---|
| pdcch-MonitoringAnyOccasions | ENUMERATED {withoutDCI-Gap, withDCI-Gap} |

OPTIONAL,

| | |
|---|---|
| dummy2 | ENUMERATED {supported} |

OPTIONAL,

| | |
|---|---|
| ue-SpecificUL-DL-Assignment | ENUMERATED {supported} |

OPTIONAL,

| | |
|---|---|
| searchSpaceSharingCA-DL | ENUMERATED {supported} |

OPTIONAL,

| | |
|---|---|
| timeDurationForQCL | SEQUENCE { |
| scs-60kHz | ENUMERATED {s7, s14, s28} |

OPTIONAL,

| | |
|---|---|
| scs-120kHz | ENUMERATED {s14, s28} |

OPTIONAL
}
OPTIONAL,
pdsch-ProcessingType1-DifferentTB-PerSlot SEQUENCE {

| | |
|---|---|
| scs-15kHz | ENUMERATED {upto2, upto4, upto7} |

OPTIONAL,

| | |
|---|---|
| scs-30kHz | ENUMERATED {upto2, upto4, upto7} |

OPTIONAL,

| | |
|---|---|
| scs-60kHz | ENUMERATED {upto2, upto4, upto7} |
| OPTIONAL, | |
| scs-120kHz | ENUMERATED {upto2, upto4, upto7} |
| OPTIONAL | |

3GPP TS 38.321 states:

5.8 Transmission and Reception without Dynamic Scheduling

### 5.8.1 Downlink

Semi-Persistent Scheduling (SPS) is configured by RRC for a Serving Cell per BWP. Multiple assignments can be active simultaneously in the same BWP. Activation and deactivation of the DL SPS are independent among the Serving Cells.
For the DL SPS, a DL assignment is provided by PDCCH, and stored or cleared based on L1 signalling indicating SPS activation or deactivation.
RRC configures the following parameters when the SPS is configured:
cs-RNTI: CS-RNTI for activation, deactivation, and retransmission;
nrofHARQ-Processes: the number of configured HARQ processes for SPS;
harq-ProcID-Offset: Offset of HARQ process for SPS;
periodicity: periodicity of configured downlink assignment for SPS.
   When the SPS is released by upper layers, all the corresponding configurations shall be released.
   After a downlink assignment is configured for SPS, the MAC entity shall consider sequentially that the N^{th} downlink assignment occurs in the slot for which:

(numberOfSlotsPerFrame×SFN+slot number in the frame)=[(numberOfSlotsPerFrame×SFN_{start time}+slot_{start time})+N×periodicity×numberOfSlotsPerFrame/10]modulo(1024×numberOfSlotsPerFrame)

where SFN_{start time} and slot_{start time} are the SFN and slot, respectively, of the first transmission of PDSCH where the configured downlink assignment was (re-)initialised.
NOTE: In case of unaligned SFN across carriers in a cell group, the SFN of the concerned Serving Cell is used to calculate the occurrences of configured downlink assignments.

3GPP R1-2100354 states:

It was agreed during last meeting that SPS group-common PDSCH is supported for MBS for RRC_CONNECTED UEs. For unicast, the activation/deactivation mechanism is based on PDCCH. For multicast, the group scheduling mechanism is using group common PDCCH and potentially UE specific PDCCH. Besides, HARQ-ACK feedback is also supported in Rel-17 MBS to improve reliability. The activation/deactivation mechanism can be considered as follows:
Activation: Both UE-specific PDCCH and group-common PDCCH can be supported to activate SPS. UE-specific PDCCH can be used to indicate PUCCH resource (e.g. ACK/NACK based feedback) per UE as well as activate SPS procedure(s). When group-common PDCCH is used to indicate the shared PUCCH resource (e.g. NACK-only based feedback), the group-common PDCCH can be used for activation of SPS for all the UEs in the same group.
Deactivation: Group-common PDCCH is used for deactivation of SPS for all the UEs in the same group. No matter what PDCCH is used for activation, to release a SPS procedure for MBS service, one PDCCH containing the same deactivation message is enough for all the UEs in a group.
   Proposal 13: Both group-common PDCCH and UE-specific PDCCH (if supported) can be used for SPS activation for MBS for RRC_CONNECTED UEs.
   Proposal 14: Group-common PDCCH is used for SPS deactivation for MBS for RRC_CONNECTED UEs.
   Based on Rel-16 NR unicast, multiple SPS procedures are supported by a UE based on configuration. According to current mechanism, multiple SPS group-common PDSCH configurations can also be supported by a UE based on configuration. However, the total number of SPS procedures supported by a UE based on capability is not supposed to be increased. How to allocation the total SPS procedures between multicast and unicast for a UE is based on network implementation.
   Proposal 15: It is supported that more than one SPS group-common PDSCH configuration per UE based on its capability.
   Proposal 16: The total number of supported SPS procedures by a UE is not increased when both multicast and unicast are supporting SPS. How to allocate the total SPS procedures between multicast and unicast is up to network implementation.
   When HARQ-ACK feedback is enabled for a multicast UE, retransmission mechanism should be considered. In NR unicast, dynamic scheduling scheme is used for HARQ-ACK feedback retransmissions. Dynamic scheduling can be also reused by retransmission(s) of SPS group-common PDSCH in multicast.
   Proposal 17: Dynamic scheduling mechanism is used for HARQ-ACK feedback retransmission(s) of SPS group-common PDSCH.

One or multiple of following terminologies may be used hereafter:
BS: A network central unit or a network node in NR which is used to control one or multiple TRPs which are associated with one or multiple cells. Communication between BS and TRP(s) is via fronthaul. BS could also be referred to as central unit (CU), eNB, gNB, or NodeB.
TRP: A transmission and reception point provides network coverage and directly communicates with UEs. TRP may be referred to as distributed unit (DU) or network node.
Cell: A cell is composed of one or multiple associated TRPs, i.e. coverage of the cell is composed of coverage of all associated TRP(s). One cell is controlled by one BS. Cell could also be referred to as TRP group (TRPG).
Serving beam: A serving beam for a UE is a beam generated by a network node, e.g. TRP, which is configured to be used to communicate with the UE, e.g. for transmission and/or reception.
Candidate beam: A candidate beam for a UE is a candidate of a serving beam. Serving beam may or may not be candidate beam.

In NR Rel-16, multiple Semi-Persistent Scheduling (SPS) configurations with smaller periodicity is introduced for providing latency-sensitive service. A UE could receive a number of time domain multiplexed (TDM) Physical Downlink Shared Channels (PDSCHs) in a slot on a cell or carrier. The number could be 2, 4, 7 based on the UE's capability. With introduction of multiple SPS configurations with smaller periodicity, the UE may encounter a situation that UE would need to receive a number of SPS PDSCH(s) more than UE's capability. In order to address this situation, the UE would prioritize a number of SPS PDSCH(s) based on SPS configuration index according to 3GPP TS 38.214. SPS PDSCH associated to lower SPS configuration index has higher priority (for prioritization when the situation happens). If there is any two or more SPS PDSCHs at least overlapping in time domain, UE would prioritize to receive a SPS PDSCH with lowest SPS configuration index among the any two or more SPS PDSCHs.

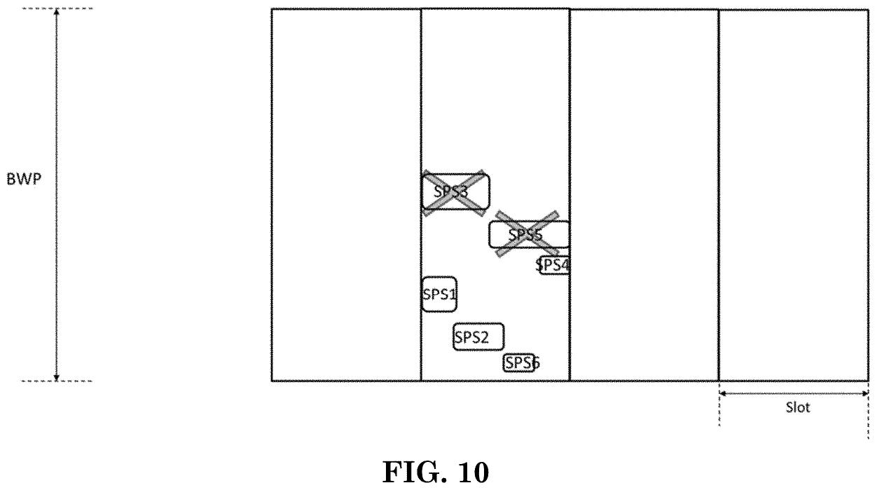

For example, as shown in FIG. 10, the UE has been configured with 6 SPS configuration (e.g., SPS1-SPS6). The UE would receive 6 SPS PDSCHs (noted as “SPS1”, “SPS2”, . . . “SPS6”) in a slot. If the UE could receive up to 4 TDM PDSCHs in a slot, the UE would prioritize to receive up to 4 SPS PDSCHs based on SPS configuration index. According to 3GPP TS 38.214, the UE would prioritize SPS1 first followed by excluding/removing (time domain) overlapping SPS PDSCH (e.g., SPS3). Then, for remaining SPS PDSCH (e.g., SPS2, SPS4, SPS5, and SPS6), the UE would prioritize SPS2 first followed by excluding or removing (time domain) overlapping SPS PDSCH (e.g., SPS5). Then, the UE would prioritize SPS4 and SPS6 (until reaching UE's capability).

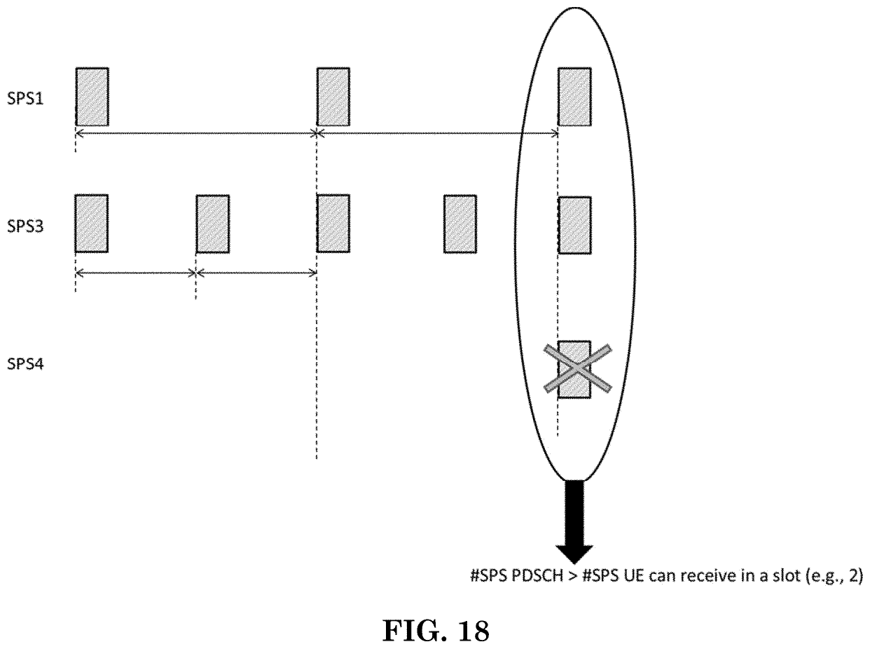

As another example, as shown in FIG. 18, due to different periodicity of SPS1, SPS3, SPS4, the UE would receive three PDSCHs which exceed the UE's capability (assuming as 2). The UE would prioritize to receive SPS PDSCH associated to SPS1 and SPS3 or prioritize to receive SPS1 and SPS3. The UE may not receive PDSCH associated to SPS4, or may not receive SPS4.

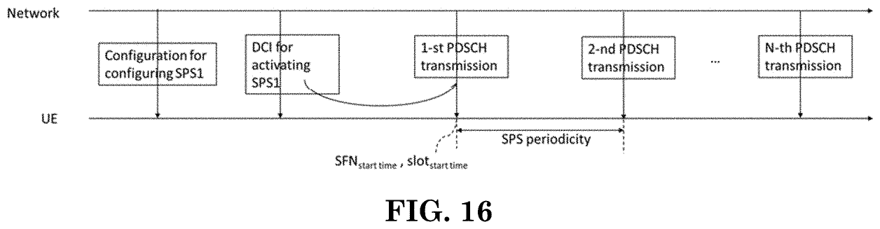

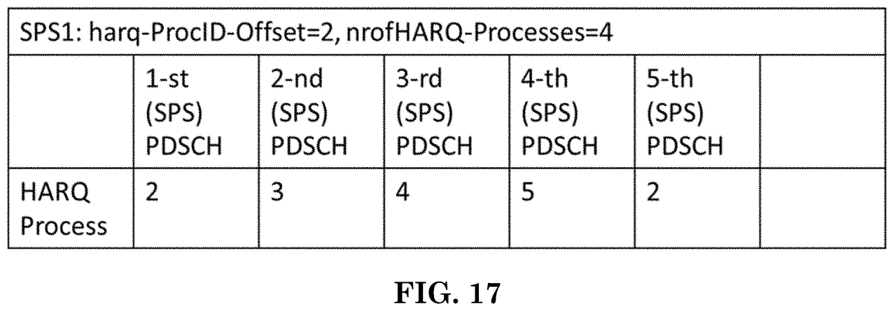

An example, shown in FIG. 16, illustrates that the UE would receive configuration for configuring SPS1 or SPS PDSCH associated to SPS1. Before receiving a DCI activating for SPS1, the UE may not receive PDSCH associated to SPS1 (since without DCI, the UE may not know frequency resource for receiving PDSCH). After or in response to DCI activating SPS1, the UE would receive 1-st PDSCH transmission based on at least the DCI and/or the configuration for SPS1. For N-th PDSCH transmission associated to SPS1, frequency resource could be derived based on the DCI, and time domain resource may be periodically or semi-persistent occur based on at least configuration of SPS1 and 1-st PDSCH associated to SPS1. As for Hybrid Automatic Repeat Request (HARQ) process shown in FIG. 17, assuming harq-ProcID-Offset=2 and number of HARQ process is 4, 1-st SPS PDSCH transmission may be associated to HARQ process 2 and with an increasing order and wrap around from 2.

In NR Rel-17, multicast service is introduced for improving substantial system efficiency and used experience. According to the Chairman Notes for 3GPP TSG RAN WG1 meeting #102-e, meeting #103-e, and meeting #104-e, one common frequency resource (CFR) is designed for providing multicast service, and CFR is restricted in one BWP of Rel-15/16. In order to provide different QoS requirement of multicast service with less control overhead, more than one SPS configurations for multicast has been considered.

Considering support unicast and multicast service, one assumption is that each cast type (e.g., unicast, multicast) can be configured with SPS configuration index {1˜8} and total number of SPS configuration for multicast and unicast is up to 8. Following this assumption, there may be an issue on how to prioritize SPS PDSCH when the situation of receiving number of SPS PDSCHs more than the UE's capability happens since SPS configuration index for unicast and multicast could be the same. Therefore, how to solve this issue may need further design and consideration.

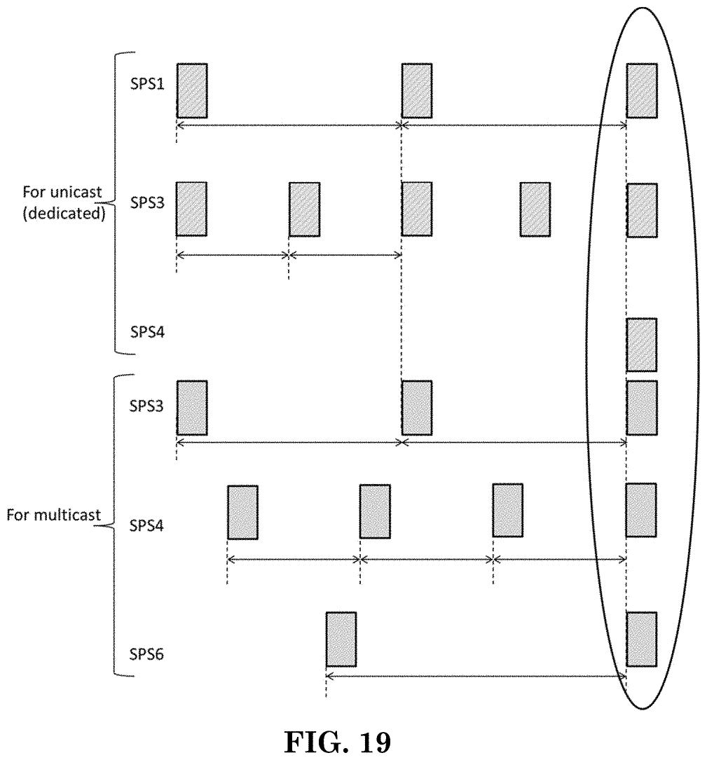

For example, as shown in FIG. 19, the UE would receive SPS1, SPS3, SPS4 for unicast and SPS3, SPS4, SPS6 for multicast according to each SPS configuration. Thus, how the UE prioritizes SPS reception may need further design and consideration.

A second issue is once the UE supporting frequency domain multiplexing (FDM) PDSCH(s) between unicast and multicast, how does the UE report this capability and how does the UE handle the situation of receiving number of SPS PDSCHs more than the UE's capability. A third issue is how to differentiate one SPS configuration associated to unicast or multicast.

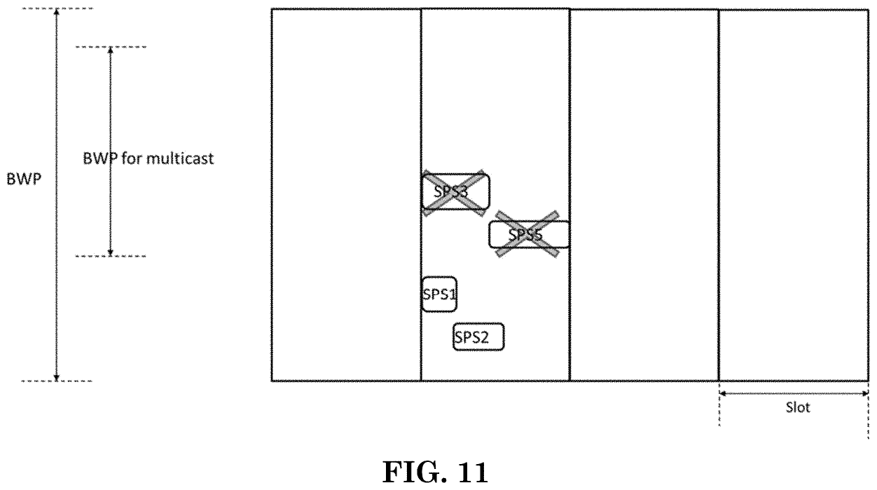

For example, as shown in FIG. 11, the assumption is that the UE could be configured to receive PDSCH(s) associated to SPS1, SPS2, SPS3, and SPS5 in a same slot, and the UE has capability to receive up to 4 unicast PDSCHs in the slot. In this example, even the UE could receive 4 unicast PDSCHs in a slot, but the UE cannot simultaneously receive SPS1 and SPS3, and SPS2 and SPS5. Thus, in this example, the UE would (prioritize) to receive PDSCH associated to SPS1 and SPS2. However, it may be too conservative and with less efficiency for multicast since the UE may have capability to receive unicast PDSCH and multicast PDSCH simultaneously. In this example, how to design the UE's capability regarding introduction of multicast PDSCH, and how to improve efficiency of downlink signal reception considering multicast PDSCH and unicast PDSCH needs further design and consideration.

Any combination of concepts discussed below can be jointly combined or formed to a new embodiment. The following embodiments can be used to solve at least (but not limited to) the issues mentioned above.

Concept 1

In general, Concept 1 is a number of SPS configuration(s) in a Bandwidth Part (BWP) on a carrier or cell is used for or shared by multicast service and non-multicast service (e.g., unicast service). Maximum number of SPS configuration(s) in a BWP may be fixed or specified, e.g. 8. A UE could receive unicast SPS PDSCH(s) in the BWP. A UE could receive non-unicast (e.g., multicast) SPS PDSCH(s) in the BWP. A UE could receive non-unicast PDSCH(s) in a common frequency resource for multicast in the BWP. The UE could receive a Downlink Control Information (DCI) for activating a SPS configuration. The DCI could schedule frequency resource for a SPS PDSCH on the common frequency resource for multicast. If the DCI is used to activate SPS configuration for multicast, frequency resource for the SPS PDSCH could be expected (by the UE) within the common frequency resource. In other words, frequency resource for the SPS PDSCH (especially for multicast) may not cross the common frequency resource for multicast. In one embodiment, the DCI being used for activating SPS configuration for multicast could be via scrambling multicast Radio Network Temporary Identifier (RNTI) (e.g., G-RNTI, GS-RNTI, GC-RNTI, GC-CS-RNTI). Additionally or alternatively, the DCI being used for activating SPS configuration for multicast could be via scrambling unicast RNTI (e.g., C-RNTI, CS-RNTI).

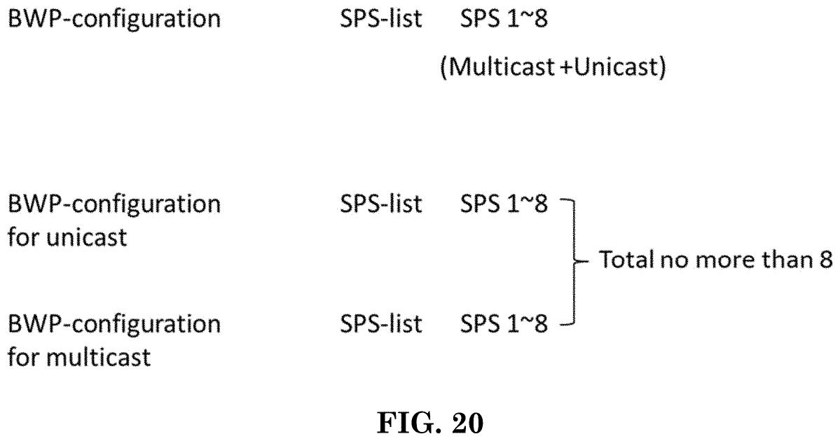

For example, as for the upper side shown in FIG. 20, the UE could be configured with one list with SPS configuration index 1˜8 for both unicast and multicast. For example, for the one list, the UE may have activated SPS configuration with index {1, 3, 5, 7} for unicast and with index {2, 4, 6, 8} for multicast. Alternatively, as for the down side shown in FIG. 20, the UE could be configured with two lists, wherein one list is for multicast and the other list is for unicast and total number of SPS configuration is no more than 8. For example, for the one list for unicast, the UE may have activated SPS configuration with index {1, 3, 5, 7} for unicast; while for the one list for multicast, the UE may have activated SPS configuration with index {2, 4, 6, 8} for multicast. For example, for the one list for unicast, the UE may have activated SPS configuration with index {1, 2, 6, 7} for unicast; while for the one list for multicast, the UE may have activated SPS configuration with index {2, 5, 6, 8} for multicast.

Concept 2

In general, Concept 2 is for a UE supporting simultaneously receiving unicast PDSCH and multicast PDSCH in a slot (on a carrier), procedure for prioritizing SPS PDSCH could be relaxed or enhanced. More specifically, if more than one PDSCH on a serving cell each without corresponding PDCCH transmission (e.g., such PDSCH could be SPS PDSCH) are in a slot, procedure for prioritizing SPS PDSCH could be relaxed or enhanced.

A UE could be configured with a first plurality of SPS configuration in a (first) BWP on a carrier or cell. The UE could be configured with one or more common frequency resource or a second BWP, which is comprised or confined by the first BWP. The first plurality of SPS configuration could comprise a second plurality of SPS configuration. The UE could be configured with a second plurality of SPS configuration. The second plurality of SPS configuration could be associated to multicast service. The first plurality of SPS configuration (excluding the second plurality of SPS configuration) could be associated to unicast service or non-multicast service. The first plurality of SPS configuration may comprise a first SPS configuration. The second plurality of SPS configuration may comprise a second SPS configuration.

The UE would receive one or more DCIs activating the first and/or the second plurality of SPS configuration. The UE would receive more than one PDSCHs associated to at least the first plurality and/or the second plurality of SPS configuration in a slot on a carrier/cell. The more than one PDSCHs may comprise at least a first PDSCH and a second PDSCH.

A number of the more than one PDSCHs could be larger than a first number. A number of the more than one PDSCHs could be larger than a second number. The first number could be associated to or derived from UE's first capability in Concept 4. The second number could be associated to or derived from UE's second capability in Concept 4.

One relaxation or enhancement could be that the UE does not exclude or remove the second PDSCH which is at least time domain overlapping with the first PDSCH if the second PDSCH is associated to the second SPS configuration which is for multicast. The first PDSCH could have a higher priority than the second PDSCH. The UE would prioritize the first PDSCH. The UE could differentiate whether the second SPS configuration is for multicast based on at least one or more method in Concept 3.

The first PDSCH could be associated to the first SPS configuration. The first SPS configuration could be for unicast or for multicast. The first SPS configuration could have a higher priority than the second SPS configuration. The first SPS configuration could have a SPS configuration index which is lower than a SPS configuration index of the second SPS configuration. Lower SPS configuration index could have higher priority (for prioritization).

The first PDSCH could be on a first resource, and the second PDSCH could be on a second resource. The first resource could start on a PRB which is different than a PRB which the second resource starts. In frequency domain, the first resource may not be overlapped with the second resource. The first resource may be at least partially overlapped with the second resource in time domain.

Text Proposal 1

In one embodiment, G-RNTI or GS-RNTI could be used to scramble Di or PDSCH associated to multicast.

If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot.
Step 1: A UE receives one PDSCH with the lowest configured sps-ConfigIndex within Q,
set j = j + 1. Designate the received PDSCH as survivor PDSCH.
Step 2: The survivor PDSCH in step 1 and any other PDSCH(s) without scrambling GS-
RNTI or G-RNTI overlapping (even partially) with the survivor PDSCH in step 1 are
excluded from Q.
Step 3: Repeat step 1 and 2 until Q is empty or j is equal to the number of unicast PDSCHs
in a slot supported by the UE.

Text Proposal 2

In one embodiment, G-RNTI or GS-RNTI could be used to scramble DCI or PDSCH associated to multicast. Exclusion from Q in following text proposal could be performed based on whether RNTI for survivor PDSCH and RNTI for any other PDSCH(s) is the same or not. If survivor PDSCH is scrambled with C-RNTI and one of any other PDSCH is scrambled with C-RNTI, the UE would exclude the one of any other PDSCH.

If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot.
Step 1: A UE receives one PDSCH with the lowest configured sps-ConfigIndex within Q,
set j = j + 1. Designate the received PDSCH as survivor PDSCH.
Step 2: The survivor PDSCH in step 1 and any other PDSCH(s) with same scrambling
RNTI overlapping (even partially) with the survivor PDSCH in step 1 are excluded from
Q.
Step 3: Repeat step 1 and 2 until Q is empty or j is equal to the number of unicast PDSCHs
in a slot supported by the UE.

Text Proposal 3

If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot
Step 1: A UE receives one PDSCH with the lowest configured sps-ConfigIndex within Q,
set j = j + 1. Designate the received PDSCH as survivor PDSCH.
Step 2: If simultaneous reception of two PDSCHs is not supported, The survivor
PDSCH in step 1 and any other PDSCH(s) overlapping (even partially) with the survivor
PDSCH in step 1 are excluded from Q, else, The survivor PDSCH in step 1 and any
other PDSCH(s) without scrambling GS-RNTI or G-RNTI overlapping (even
partially) with the survivor PDSCH in step 1 are excluded from Q.
Step 3: Repeat step 1 and 2 until Q is empty or j is equal to the number of unicast PDSCHs
in a slot supported by the UE

Text Proposal 4

Any other PDSCH(s) which is overlapping (even partially) with the survivor PDSCH is excluded.

If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot.
Step 1: A UE receives one PDSCH with the lowest configured sps-ConfigIndex within Q,
set j = j + 1. Designate the received PDSCH as survivor PDSCH.
Step 2: If simultaneous reception of two PDSCHs is not supported, The survivor
PDSCH in step 1 and any other PDSCH(s) overlapping (even partially) with the survivor
PDSCH in step 1 are excluded from Q, else, The survivor PDSCH in step 1 and any
other PDSCH(s) with same scrambling RNTI overlapping (even partially) with the
survivor PDSCH in step 1 are excluded from Q.
Step 3: Repeat step 1 and 2 until Q is empty or j is equal to the number of unicast PDSCHs
in a slot supported by the UE.

Additionally and/or alternatively, one relaxation or enhancement could be that UE would prioritize or derive at most the first number of PDSCH(s) among the more than one PDSCH(s) based on at least a rule.

In one embodiment, the rule could be cyclic of multicast and unicast. The rule could start from the lowest SPS configuration index among the more than one PDSCH(s). If the lowest SPS configuration index for a SPS PDSCH is for multicast, the rule would be MUMUMU . . . . If the lowest SPS configuration index for a SPS PDSCH is for unicast, the rule would be UMUMUM . . . .

In one embodiment, the rule could (always) start from a SPS configuration for unicast with the lowest SPS configuration index among the more than one PDSCH(s). The rule could (always) start from a SPS configuration for multicast with the lowest SPS configuration index among the more than one PDSCH(s). The rule could be applied for each pair of cyclic or each pair of {U, M} and preferably based on at least the lowest SPS configuration index among (remaining of) the more than one PDSCH(s).

In one embodiment, the rule could be sequential of multicast and unicast. The rule could start from the lowest SPS configuration index among the more than one PDSCH(s). If the lowest SPS configuration index for a SPS PDSCH is for multicast, the rule would be M . . . MU . . . U. If the lowest SPS configuration index for a SPS PDSCH is for unicast, the rule would be U . . . UM . . . M. The rule could (always) start from a SPS configuration for unicast with the lowest SPS configuration index among the more than one PDSCH(s). The rule could (always) start from a SPS configuration for multicast with the lowest SPS configuration index among the more than one PDSCH(s).

For example, assuming the more than one PDSCH(s) are {SPS1-SPS6}, and SPS1, SPS2, SPS4 are for unicast and SPS3, SPS5, SPS6 are for multicast. The rule would start from SPS1 followed by SPS3, followed by SPS2, SPS5 (in one embodiment), and followed by SPS4, SPS6 (in one embodiment). In this example, if UE supports 4 PDSCH reception in a slot on a carrier/cell, the UE, (after the procedure for prioritizing), could receive SPS1, SPS2, SPS3, SPS5.

As another example, the more than one PDSCH(s) are {SPS1˜SPS6}, and SPS1, aPe4, aPS5 are for unicast and SPS2, Pw3, SPS6 are for multicast. The rule would start from SPS1 followed by SPS2. The UE would consider remaining SPS (e.g., SPS3, SPS4, SPS5, SPS6), and would prioritize SPS PDSCH based on lowest SPS configuration index (e.g., SPS3). In this example, the rule (after SPS1 and SPS2) would start from SPS3 followed by SPS4. In other words, the rule may be UMMUUM. Each pair of cyclic or each pair of {U, M} would be derived based on at least the lowest SPS configuration index (among the remaining SPS PDSCH).

Text Proposal 5

In one embodiment, PDSCH with different scrambling RNTI could be replaced or equivalent to PDSCH for different cast type.

If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot.
Step 1: A UE receives one PDSCH with the lowest configured sps-ConfigIndex within Q,
set j = j + 1. Designate the received PDSCH as survivor PDSCH.
Step 2: The survivor PDSCH in step 1 and any other PDSCH(s) overlapping (even
partially) with the survivor PDSCH in step 1 are excluded from Q.
Step 3: Repeat step 1 and 2 and selects PDSCH(s) with different scrambling RNTI
than survivor PDSCH in step 1, if any, until Q is empty or j is equal to the number of
unicast PDSCHs in a slot supported by the UE.

Additionally and/or alternatively, one relaxation or enhancement is that the UE would reserve or prioritize one SPS PDSCH for multicast. The UE would prioritize or derive a SPS PDSCH with lowest SPS configuration index and the SPS PDSCH is for multicast among the more than one PDSCHs. The UE would reserve or prioritize the derived SPS PDSCH with the lowest SPS configuration index which is for multicast. The spirit is to reserve or prioritize one SPS PDSCH for multicast and most SPS PDSCH for unicast among the more than one PDSCHs. In one embodiment, the SPS PDSCH with lowest SPS configuration index may (limit or restrict to) be with SPS configuration index less than or equal to a multicast-prioritized threshold. Since SPS PDSCH for unicast may associate to latency-sensitive transmission, it may be good to guarantee the UE could mostly receive SPS PDSCH for unicast.

If the UE supports simultaneous reception of multicast PDSCH and unicast PDSCH, after the UE prioritizes or derives the SPS PDSCH with lowest SPS configuration index for multicast, the UE may not exclude or remove SPS PDSCH for unicast, and/or the UE would exclude (remaining) SPS PDSCH for multicast. After the UE prioritizes or derives the SPS PDSCH with lowest SPS configuration index for multicast, the UE would prioritize or derive SPS PDSCH for unicast and/or skip receiving (remaining) SPS PDSCH for multicast.

If the UE does not support simultaneous reception of multicast PDSCH and unicast PDSCH, the UE would exclude any other SPS PDSCH(s) which is overlapped with the SPS PDSCH with lowest SPS configuration index and for multicast.

Alternatively, the UE would prioritize or derive a SPS PDSCH with lowest SPS configuration index and the SPS PDSCH is for unicast among the more than one PDSCHs. If the UE supports simultaneous reception of multicast PDSCH and unicast PDSCH, after the UE prioritizes or derives the SPS PDSCH with lowest SPS configuration index for unicast, the UE may not exclude or remove SPS PDSCH for multicast, and/or the UE would exclude SPS PDSCH for unicast. Additionally or alternatively, after the UE prioritizes or derives the SPS PDSCH with lowest SPS configuration index for unicast, the UE would prioritize or derive SPS PDSCH for unicast and/or skip receiving SPS PDSCH for multicast. If the UE does not support simultaneous reception of multicast PDSCH and unicast PDSCH, the UE would exclude any other SPS PDSCH(s) which is overlapped with the SPS PDSCH with lowest SPS configuration index and for multicast. The UE may reserve one SPS PDSCH for multicast among the more than one PDSCHs. The one SPS PDSCH for multicast may be with the lowest SPS configuration index among the more than one PDSCHs and for multicast.

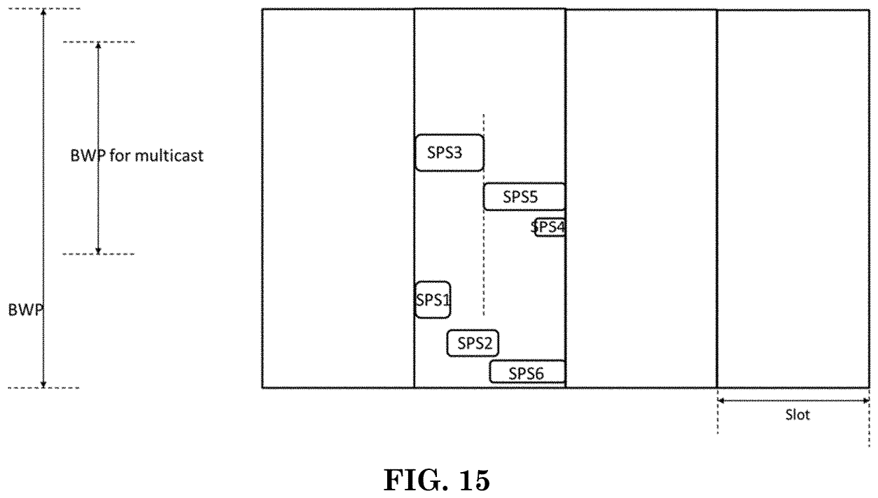

For example, as shown in FIG. 15, assuming UE would receive at most 4 PDSCHs in a slot, and supports simultaneous reception of multicast and unicast PDSCH. The UE would receive SPS3 which is for multicast. Even when SPS3 is with higher SPS configuration index than SPS1 for unicast, the UE would prioritize to receive SPS3. Based on the procedure (for prioritization), the UE would receive SPS1. The UE may exclude SPS2 or does not receive SPS2 (since the UE's capability can allow (only) receive one pair of unicast and multicast PDSCH). The UE would receive SPS6 for unicast (even there are SPS4, SPS5 with lower SPS configuration index). The UE would receive SPS1, SPS3, SPS6 which are below UE's capability (e.g., at most 4 PDSCHs).

Additionally and/or alternatively, one relaxation or enhancement could be that the UE would handle same SPS configuration index based on a rule when there are at least two SPS PDSCH with same SPS configuration index associated to unicast and multicast, respectively. The UE could be configured by network with the rule. The rule could be specified in standard. The rule could be used to define priority between SPS configuration for multicast and SPS configuration for unicast. The rule could be associated to each SPS configuration for multicast. The rule could be associated to a downlink BWP or PDSCH configuration. The rule could be (always) multicast first for same SPS configuration index (SPS1(M)>SPS1(U), SPS2(M)>SPS2(U)). The rule could be (always) unicast first for same SPS configuration index (SPS1(U)>SPS1(M), SPS2(U)>SPS2(M)). The rule could be two unicasts followed by one multicast, (SPS1(U)>SPS2(U)>SPS1(M)>SPS3(U)>SPS4(U)>SPS2(M)). The rule could be one multicast followed by two unicasts (SPS1(M)>SPS1(U)>SPS2(U)>SPS2(M)>SPS3(U)>SPS4(U)). The UE could prioritize or derive to receive SPS PDSCH(s) based on at least the rule (and the procedure for prioritization).

Additionally and/or alternatively, one relaxation or enhancement could be that UE would perform procedure for multicast and unicast, respectively. In one embodiment, the UE would prioritize to receive half of the first number of PDSCHs for multicast or receive a first integer of the first number of PDSCHs for multicast, wherein the half of the first number may be with ceil or floor operation. The UE would prioritize to receive half of the first number of PDSCHs for unicast or receive a second integer of the first number of PDSCHs for unicast, wherein the half of the first number may be with ceil or floor operation. The first number may be consisted of the first integer and the second integer. In one embodiment, based on at least the procedure for multicast and the procedure for unicast, the UE would receive at most the first number of PDSCHs including multicast and unicast in a slot. The UE would support simultaneous reception of multicast and unicast PDSCH.

For example, as shown in FIG. 15, assuming the UE would receive at most 4 PDSCHs in a slot, and the UE would perform the procedure for prioritizing PDSCH for multicast and for unicast, respectively. In this example, the UE would prioritize 2 multicast PDSCHs which could be SPS3 and SPS4, and the UE would prioritize 2 unicast PDSCHs which could be SPS1 and SPS2.

As another example, as shown in FIG. 6, assuming the UE's capability can (only) supports one pair of (FDM) unicast and multicast PDSCH. The UE would prioritize SPS1 from {SPS1, SPS2, SPS6} which are for unicast PDSCH, and prioritize SPS3 from {SPS3, SPS4, SPS5} which are for multicast PDSCH.

Text Proposal 6

A UE receives unicast PDSCH(s) based on following paragraph with change of
replacing the number of unicast PDSCHs in a slot supported by the UE with half the
number of unicast PDSCHs in a slot supported by the UE, preferably with ceil or floor
operation, and/or
replacing PDSCH with unicast PDSCH.
A UE receives multicast PDSCH(s) based on following paragraph with change of
replacing the number of unicast PDSCHs in a slot supported by the UE with half the
number of unicast PDSCHs in a slot supported by the UE, preferably with ceil or floor
operation, and/or
replacing PDSCH with multicast PDSCH.
If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot.
Step 1: A UE receives one PDSCH with the lowest configured sps-ConfigIndex within Q,
set j = j + 1. Designate the received PDSCH as survivor PDSCH.
Step 2: The survivor PDSCH in step 1 and any other PDSCH(s) overlapping (even
partially) with the survivor PDSCH in step 1 are excluded from Q.
Step 3: Repeat step 1 and 2 until Q is empty or j is equal to the number of unicast PDSCHs
in a slot supported by the UE.

Additionally and/or alternatively, one relaxation or enhancement could be that UE would prioritize PDSCH reception based on at least a threshold. The threshold could be configured per BWP, per PDSCH configuration, per UE, and/or per SPS configuration. The threshold could be (associated to) a SPS configuration index. For a SPS PDSCH with SPS configuration index lower than (or equal to) the threshold, SPS PDSCH for multicast could be prioritized (than for unicast). In one embodiment, SPS PDSCH with SPS configuration index higher than (or equal to) the threshold, SPS PDSCH for unicast could be prioritized (than for multicast). Alternatively, for SPS PDSCH with SPS configuration index lower than (or equal to) the threshold, SPS PDSCH for unicast could be prioritized (than for multicast). In one embodiment, SPS PDSCH with SPS configuration index higher than (or equal to) the threshold, SPS PDSCH for multicast could be prioritized (than for unicast).

For example, SPS PDSCH for multicast is with SPS configuration index 1˜8, and SPS PDSCH for unicast is with SPS configuration index 1˜8, and assuming the threshold is 2. The UE would prioritize multicast than unicast for SPS configuration index smaller than (or equal to) the threshold, and the prioritization order would be (SPS1(M)>SPS1(U)>SPS2(M)>SPS2(U)) or (SPS1(M)>SPS2(M)>SPS1(U)>SPS2(U)). The UE would prioritize unicast than multicast for SPS configuration index larger than (or equal to) the threshold, and the prioritization order would be (SPS3(U)>SPS3(M)>SPS4(U)>SPS4(M)) or (SPS3(U) . . . >SPS8(U)>SPS3(M) . . . >SPS8(M)).

Additionally or alternatively, for SPS PDSCH with SPS configuration index lower than (or equal to) the threshold, SPS PDSCH for multicast could be prioritized (e.g. the SPS PDSCH for multicast can prioritize than SPS PDSCH for unicast with larger index). In one embodiment, for a SPS PDSCH with SPS configuration index higher than (or equal to) the threshold, it could be prioritized if the SPS PDSCH is for unicast, and/or it could be deprioritized if the SPS PDSCH is for multicast. Alternatively, for SPS PDSCH with SPS configuration index lower than (or equal to) the threshold, SPS PDSCH for unicast could be prioritized (e.g. the SPS PDSCH for unicast can prioritize than SPS PDSCH for multicast with larger index). In one embodiment, for a SPS PDSCH with SPS configuration index higher than (or equal to) the threshold, it could be prioritized if the SPS PDSCH is for multicast, and/or it could be deprioritized if the SPS PDSCH is for unicast.

Additionally and/or alternatively, one relaxation or enhancement could be that UE would prioritize each pair of multicast PDSCH and unicast PDSCH. One pair of multicast PDSCH and unicast PDSCH may mean the UE would receive the multicast PDSCH and the unicast PDSCH simultaneously or the multicast PDSCH and the unicast PDSCH is at least time domain overlapping and is not overlapped in frequency domain. The UE may perform the procedure or prioritize PDSCH reception based on lowest SPS configuration index. The UE may exclude SPS PDSCH(s) with same cast type (e.g., with same scrambling RNTI) and/or the SPS PDSCH with lowest SPS configuration index from the more than one SPS PDSCHs.

If a SPS PDSCH with the lowest SPS configuration index among the more than one SPS configurations is (for/associated with) multicast, the UE would derive a SPS PDSCH for unicast as one pair. The derived SPS PDSCH for unicast may be time domain overlapping but frequency domain non-overlapping with the SPS PDSCH for multicast. The derived SPS PDSCH for unicast may be with lowest SPS configuration index. Additionally and/or alternatively, the derived SPS PDSCH for unicast may be with lowest SPS configuration index if there are more than one SPS PDSCH for unicast which is time domain overlapping but frequency domain non-overlapping with the SPS PDSCH for multicast. If a SPS PDSCH with the lowest SPS configuration index among the more than one SPS configurations is (for/associated with) unicast, the UE would derive a SPS PDSCH for multicast as one pair. The derived SPS PDSCH for multicast may be time domain overlapping but frequency domain non-overlapping with the SPS PDSCH for unicast. The derived SPS PDSCH for multicast may be with lowest SPS configuration index. Additionally and/or alternatively, the derived SPS PDSCH for multicast may be with lowest SPS configuration index if there are more than one SPS PDSCH for multicast which is time domain overlapping but frequency domain non-overlapping with the SPS PDSCH for unicast. The UE would exclude any SPS PDSCH(s) overlapping (even partially overlapping) with any one of the pair of multicast PDSCH and unicast PDSCH.

Text Proposal 5

If more than one PDSCH on a serving cell each without a corresponding PDCCH transmission
are in a slot, after resolving overlapping with symbols in the slot indicated as uplink by tdd-UL-
DL-ConfigurationCommon, or by tdd-UL-DL-ConfigurationDedicated, a UE receives one or
more PDSCHs without corresponding PDCCH transmissions in the slot as specified below.
Step 0: set j = 0, where j is the number of selected PDSCH(s) for decoding. Q is the set of
activated PDSCHs without corresponding PDCCH transmissions within the slot.
Step 1: A UE receives one PDSCH with the lowest configured sps-ConfigIndex within Q,
set j = j + 1. Designate the received PDSCH as survivor PDSCH.
Step 2: If simultaneous reception of two PDSCHs is not supported, The survivor
PDSCH in step 1 and any other PDSCH(s) overlapping (even partially) with the survivor
PDSCH in step 1 are excluded from Q. Else, The survivor PDSCH in step 1 and any
other PDSCH(s) with same scrambling RNTI overlapping (even partially) with the
survivor PDSCH in step 1 are excluded from Q, and the UE receives one PDSCH
with different scrambling RNTI than the survivor PDSCH in step 1, overlapping
with the survivor PDSCH in step 1, and with the lowest configured sps-ConfigIndex
within Q, set j = j + 1. Designate the received PDSCH as survivor PDSCH, and the
survivor PDSCH in step 2 and any other PDSCH(s) overlapping (even partially) with
the survivor PDSCH in step 2 are excluded from Q.
Step 3: Repeat step 1 and 2 until Q is empty or j is equal to the number of unicast PDSCHs
in a slot supported by the UE.

In one embodiment, UE exclude one PDSCH (in the procedure) may comprise the UE does not receive the one PDSCH. The UE may not prioritize one PDSCH (in the procedure) may comprise UE does not receive the one PDSCH.

Concept 3

In general, Concept 3 is to differentiate whether a SPS configuration is multicast or unicast based on an explicit way or an implicit way. The explicit way could be differentiating by a parameter and/or a signaling and/or a RNTI. The implicit way could be differentiating by frequency location of SPS resource(s). In one embodiment, the explicit way and implicit way could be used as a hybrid way for differentiating.

The parameter may be a flag indicative of multicast or non-multicast. The parameter may be a flag indicative of unicast or non-unicast. The parameter may be present when network provides or supports multicast service. The parameter could be provided by SPS configuration in the BWP. The parameter may be in a DCI for activating a SPS configuration. The parameter could indicate whether one SPS configuration supports one or more cast type. The parameter could indicate whether one SPS configuration supports multicast or not. If the one SPS configuration supports multicast, a network could activate the one SPS configuration for multicast based on the RNTI.

A UE could differentiate or derive whether a SPS configuration is for multicast based on the parameter or the flag. For example, if the parameter or the flag in the SPS configuration indicates “multicast”, the UE would consider the SPS configuration is for multicast.

A UE could differentiate or derive an activated SPS is for multicast if the DCI for activating allocates or schedules SPS frequency resource(s) within common frequency region for multicast or with the second BWP. A UE could differentiate or derive an activated SPS is for unicast if the DCI for activating allocates or schedules SPS frequency resource(s) not in common frequency region for multicast.

The signaling may be a DCI for activating one SPS configuration. The RNTI may be an RNTI (CRC-)scrambled with the DCI for activating one SPS configuration. A UE could differentiate whether a SPS configuration is for multicast based on the signaling and/or the RNTI. If the RNTI is GS-RNTI or G-RNTI or RNTI for (SPS) multicast, the one SPS configuration could be activated for multicast. If the RNTI is C-RNTI, CS-RNTI or RNTI for unicast or non-multicast, the one SPS configuration could be activated for unicast or non-multicast.

Concept 4

In general, Concept 4 is that a UE would report UE's capability regarding simultaneous reception of unicast and multicast (to a network). In one embodiment, the UE could report a first capability of a first number of TDM unicast PDSCH in a slot on a carrier or cell. Additionally and alternatively, the UE could report a first capability of a first number of TDM and/or FDM PDSCHs in a slot on a carrier or cell. Additionally and alternatively, the UE could report a first capability of a first number of pair of FDM PDSCH in a slot on a carrier or cell. In one embodiment, a first pair of FDM PDSCH may be non-overlapped in time domain with a second pair of FDM PDSCH. The UE could report a first capability of a first number of pair of unicast PDSCH and multicast PDSCH in a slot on a carrier or cell. In one embodiment, a first pair of unicast PDSCH and multicast PDSCH may be non-overlapped in time domain with a second pair of unicast PDSCH and multicast PDSCH.

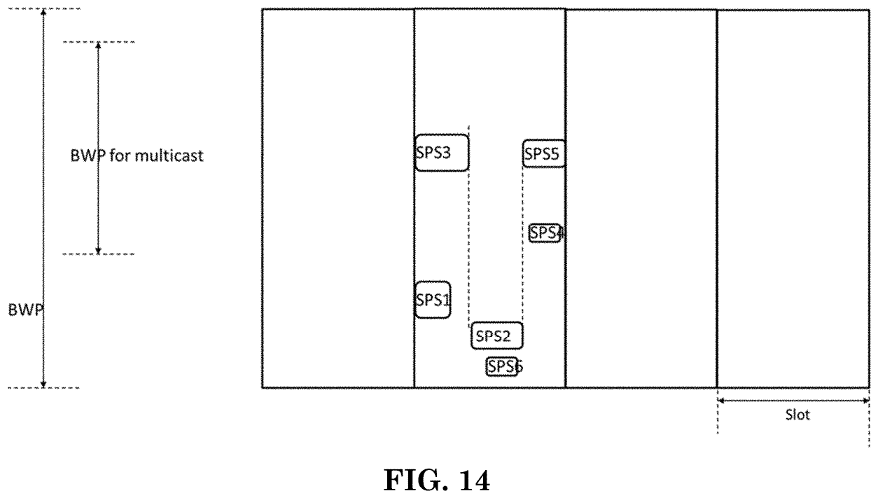

For example, as shown in FIG. 14, there are three pairs of FDM PDSCH in a slot, {SPS1, SPS3} {SPS2, SPS6} {SPS4, SPS5}. Different pairs of FDM PDSCH may not overlap in time domain.

In one embodiment, the UE could report a second capability of whether support a second number of simultaneous PDSCH reception. The UE could report a second capability of whether support a second number of FDM PDSCH reception. The second capability could indicate whether support simultaneous PDSCH reception or FDM PDSCH reception. The second capability could indicate whether support simultaneous PDSCH reception of unicast and multicast. The second capability could indicate how many FDM PDSCH in a pair of FDM PDSCH. The second capability could indicate an offset for reduction of the first capability. Since simultaneous reception of PDSCH(s), or simultaneous reception of multicast PDSCH and unicast PDSCH may need more buffer to buffering, the first number for receiving separated or TDM PDSCHs in a slot may not be suitable. In one embodiment, the offset may be used for one pair of simultaneous reception of PDSCH(s). The offset may be used for each pair of simultaneous reception of PDSCH(s).

In one embodiment, simultaneous PDSCH reception may mean two PDSCHs are at least partially overlapped in time domain. Simultaneous PDSCH reception may mean two PDSCHs are separated in frequency domain (without overlapping), but at least partially overlapped in time domain.

In one embodiment, the second number may be two. The second number of simultaneous PDSCH may comprise at least one unicast PDSCH and one multicast PDSCH. The second number of simultaneous PDSCH may comprise (only) two unicast PDSCHs or (only) two multicast PDSCHs.

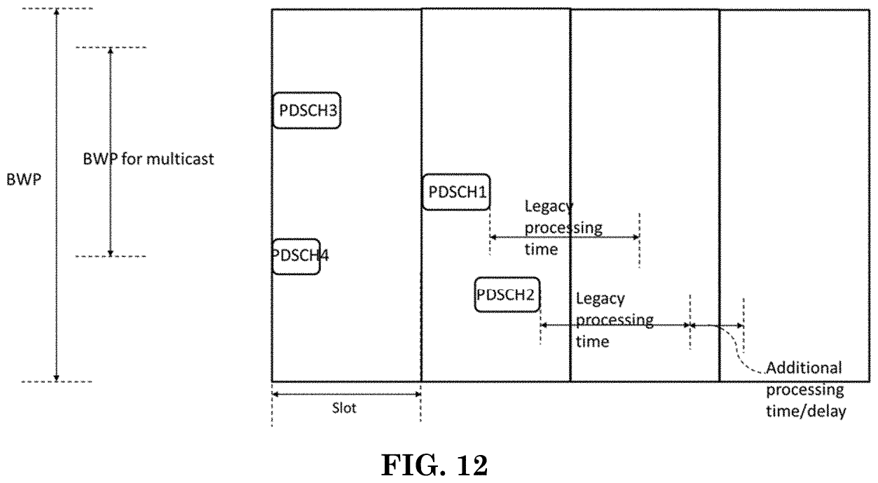

The UE could report a third capability of an (additional) processing time or delay. The (additional) processing time or delay could be used to ensure there is enough time for processing due to simultaneous receiving PDSCH. For example, as shown in FIG. 12, as for PDSCH1 and PDSCH2, the UE would receive PDSCH1 and PDSCH2 simultaneously (due to partial overlapping). For PDSCH2 or the latter one, the (additional) processing time or delay could be applied. The UE may not expect to multiplex HARQ-ACK feedback or provide HARQ-ACK feedback before total time of legacy processing time and/plus (additional) processing time or delay. In this example, the UE may not apply the (additional) processing time/delay on PDSCH1. As for PDSCH3 and PDSCH4, the UE may determine which PDSCH needs to apply the (additional) processing time or delay based on time domain order of DCI scheduling for each PDSCH. The time domain order could be starting OFDM symbol of DCI scheduling for PDSCH.

As for one pair of FDM PDSCHs, the UE could apply the (additional) processing time/delay for
PDSCH of the one pair of FDM PDSCHs, which the PDSCH is with earlier/latter OFDM symbol, and/or
PDSCH of the one pair of FDM PDSCHs, which a DCI scheduling the PDSCH is on earlier/latter OFDM symbol, and/or
PDSCH of the one pair of FDM PDSCHs, which is without/with DCI for scheduling, and/or
PDSCH of the one pair of FDM PDSCHs, which the PDSCH starts in a PRB with higher/lower PRB index, and/or
PDSCH of the one pair of FDM PDSCHs, which is associated to multicast/unicast, and/or
PDSCH of the one pair of FDM PDSCHs, which is associated to a higher/lower SPS configuration index.

In one embodiment, as for the other PDSCH of the one pair of FDM PDSCH, the UE may not apply (additional) processing time or delay.

The UE would report the second capability that the UE supports simultaneous PDSCH reception of unicast and multicast. In response that the UE reports the second capability, the UE would perform procedure for prioritizing SPS PDSCH based on the second capability. More specifically, if the UE would transmit more than one PDSCHs in a slot on a carrier/cell, and the more than one PDSCHs comprises at least one unicast PDSCH and one multicast PDSCH, the UE would perform procedure for prioritizing SPS PDSCH based on the second capability (rather than the first capability).

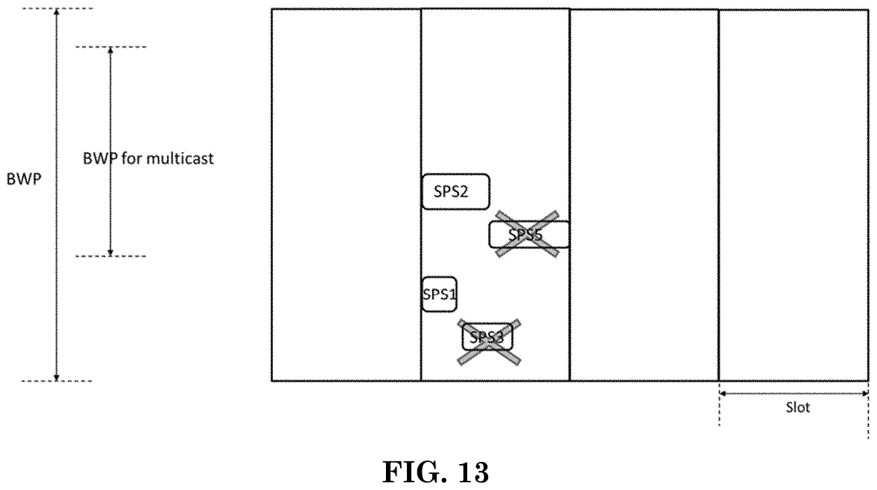

For example, as shown in FIG. 13, first capability could indicate the first number as 141 and second capability could indicate the second number as 121. The UE would perform the procedure based on the second number, and prioritize SPS1 (i.e., SPS PDSCH1) and SPS2 (i.e., SPS PDSCH2). The UE may not receive SPS3 and SPS5. Alternatively, the UE could receive SPS5 (since the first number indicates as 4).

In one embodiment, if number of the more than one PDSCHs is two, the UE could perform procedure for prioritizing SPS PDSCH based on the second capability. If the more than one PDSCHs does not comprise at least one unicast PDSCH and one multicast (and number of the more than one PDSCHs is more than two), the UE would perform procedure for prioritizing SPS PDSCH based on the first capability. For example, if all the more than one PDSCH is either for unicast SPS PDSCH or for multicast SPS PDSCH (and number of the more than one PDSCHs is more than two), the UE would perform procedure for prioritizing SPS PDSCH based on the first capability.

The UE would derive number of pair of FDM PDSCH in a slot on a carrier or cell based on the first capability and the second capability. The number of pair of FDM PDSCH could be that the first number divide the second number (e.g., the first number/the second number), preferably with ceil or floor operation. Alternatively, the UE would derive number of pair of FDM PDSCH in a slot on a carrier or cell based on the first capability. In other words, the number of pair of FDM PDSCH in a slot may be the first number.

More specifically, if the UE would transmit more than one PDSCHs in a slot on a carrier or cell, and the more than one PDSCHs comprises at least one unicast PDSCH and one multicast PDSCH, the UE would perform procedure for prioritizing SPS PDSCH based on the second capability and the first capability. In one embodiment, the UE would perform procedure for prioritizing SPS PDSCH based on how many pair of FDM PDSCH could be received in a slot supported by UE's first and second capability.

In one embodiment, the more than one PDSCHs may be without corresponding PDCCH transmission. The UE derives or prioritizes a first SPS PDSCH with lowest SPS configuration index among the more than one PDSCHs in a slot. If the first SPS PDSCH is unicast, the UE would derive a second SPS PDSCH for multicast (for pairing with the first SPS PDSCH). The second SPS PDSCH may be overlapped with the first SPS PDSCH in time domain. The second SPS PDSCH may not be overlapped with the first SPS PDSCH in frequency domain. The UE would exclude SPS(s) (from the more than one PDSCHs without including the first and second SPS PDSCH) which are overlapped with the first SPS PDSCH and/or the second SPS PDSCH. After determining the first pair of (FDM) PDSCH (e.g., the first SPS PDSCH and the second SPS PDSCH), the UE could derive the second pair of (FDM) PDSCH from (remaining) the more than one PDSCHs until there are no remaining PDSCH, or till the first and/or the second UE's capability.

For example, as shown in FIG. 13, first capability could indicate the first number as 141 and second capability could indicate the second number as 121. The UE would prioritize SPS1 and SPS2 which could be a pair of FDM PDSCH for multicast SPS PDSCH and unicast SPS PDSCH. More specifically, the UE would prioritize SPS1 (which is a unicast) first, and does not exclude SPS2 since SPS2 is a multicast. Then, the UE would prioritize SPS2, and exclude SPS3, since SPS2 has a paired unicast SPS (e.g., SPS1). Then, the UE could prioritize SPS5. In this example, the UE, based on the second capability and the first capability, could receive 2 pair of FDM PDSCH in a slot. The UE could receive {SPS1, SPS2}, {SPS5}.

As another example, as shown in FIG. 14, first capability could indicate the first number as {4} and second capability could indicate the second number as {2}. Since there are only two pair of FDM PDSCH supported by the UE, the UE would prioritize at most two pair of FDM PDSCH. In this example, the three pair of FDM PDSCH could be {SPS1, SPS3}, {SPS2, SPS6}, {SPS5, SPS4}. Based on lowest index in each pair of FDM PDSCH, the UE would prioritize {SPS1, SPS3}, {SPS2, SPS6}. Based on earlier starting OFDM symbol, the UE would prioritize{SPS1, SPS3}, {SPS2, SPS6}.

As another example, as shown in FIG. 15, first capability could indicate the first number as 141 and second capability could indicate the second number as 121. Since there are only two pairs of FDM PDSCH supported by the UE, the UE would prioritize at most two pair of FDM PDSCH. In this example, the two pairs of FDM PDSCH could be {SPS1, SPS3}, {SPS4, SPS6}. The first pair of FDM PDSCH could be derived from one unicast SPS PDSCH and one multicast SPS PDSCH. The first pair of FDM PDSCH could be derived from the lowest SPS configuration index among SPS PDSCH in the slot. In this example, SPS1 could be an unicast SPS PDSCH, and the UE could derive an SPS for multicast and pairing SPS1 (e.g., SPS3). When one pair is derived, the UE would exclude overlapping SPS (e.g., SPS2). With the remaining SPSs being {SPS4, SPS5, SPS6}, the UE would start from the SPS with lowest SPS configuration index (e.g., SPS4). Since SPS4 is a multicast, the UE would derive an SPS for unicast (e.g., SPS6) for pairing SPS4 and/or exclude SPS5 (which is for multicast).

Any concept, embodiment, method, text proposal, and/or enhancement can be combined for a new concept, embodiment, method, text proposal, and/or enhancement. Throughout the invention, the invention describes behavior or operation of a single serving cell unless otherwise noted. Throughout the invention, “UE is configured” can be replaced by “UE receives a signal for configuring” or “UE receives a configuration for”. Throughout the invention, “network configures” can be replaced by “network transmits a signal for configuring” or “network transmits a configuration for”. Throughout the invention, “network” can be replaced by “gNB” or “eNB” or “BS (base station)”.

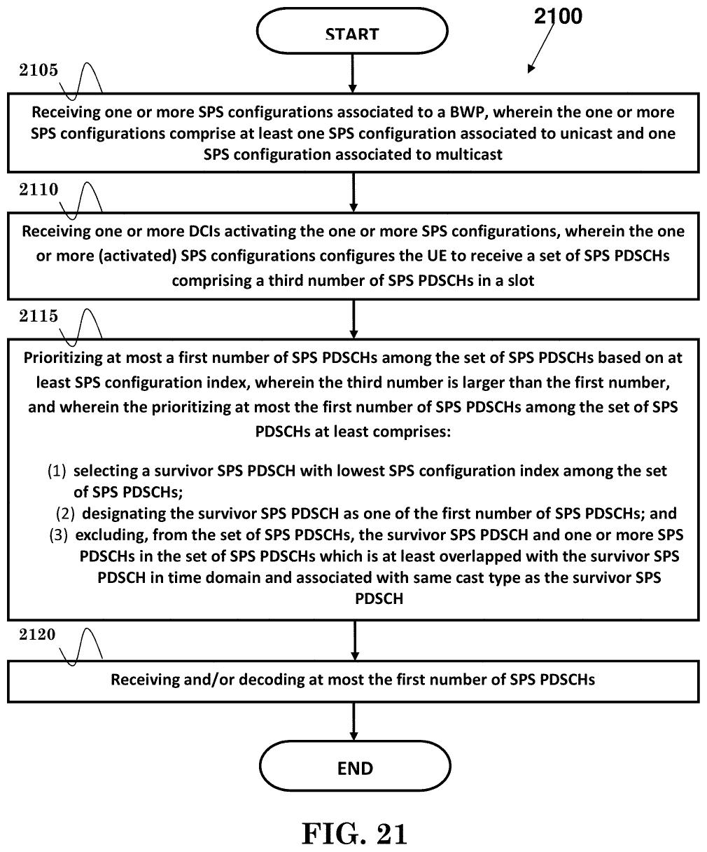

FIG. 21 is a flow chart 2100 according to one exemplary embodiment from the perspective of a UE. In step 2105, the UE receives one or more SPS configurations associated to a BWP, wherein the one or more SPS configurations comprise at least one SPS configuration associated to unicast and one SPS configuration associated to multicast. In step 2110, the UE receives one or more DCIs activating the one or more SPS configurations, wherein the one or more (activated) SPS configurations configures the UE to receive a set of SPS PDSCHs comprising a third number of SPS PDSCHs in a slot.

In step 2115, the UE prioritizes at most a first number of SPS PDSCHs among the set of SPS PDSCHs based on at least SPS configuration index, wherein the third number is larger than the first number, and wherein the prioritizing at most the first number of SPS PDSCHs among the set of SPS PDSCHs at least comprises:
(1) selecting a survivor SPS PDSCH with lowest SPS configuration index among the set of SPS PDSCHs; and
(2) designating the survivor SPS PDSCH as one of the first number of SPS PDSCHs; and
(3) excluding, from the set of SPS PDSCHs, the survivor SPS PDSCH and one or more SPS PDSCHs in the set of SPS PDSCHs which is at least overlapped with the survivor SPS PDSCH in time domain and associated with same cast type as the survivor SPS PDSCH.

In step 2120, the UE receives and/or decodes at most the first number of SPS PDSCHs.

In one embodiment, the prioritizing at most the first number of SPS PDSCHs among the set of SPS PDSCHs may comprise at least any one or any combination of following:
(1) excluding, from the set of SPS PDSCHs, the survivor SPS PDSCH and one or more SPS PDSCHs in the set of SPS PDSCHs which is at least overlapped with the survivor SPS PDSCH in time domain and with a same cyclic redundancy check (CRC) scrambling Radio Network Temporary Identifier (RNTI) as the survivor SPS PDSCH, and/or
(2) not excluding, from the set of SPS PDSCHs, one or more SPS PDSCHs in the set of SPS PDSCHs which is at least overlapped with the survivor SPS PDSCH in time domain and associated with different cast type than the survivor SPS PDSCH, and/or
(3) excluding, from the set of SPS PDSCHs, the survivor SPS PDSCH and one or more SPS PDSCHs in the set of SPS PDSCHs which is at least overlapped with the survivor SPS PDSCH in time domain and with same CRC scrambling RNTI as the survivor SPS PDSCH, and/or
(4) not excluding, from the set of SPS PDSCHs, one or more SPS PDSCHs in the set of SPS PDSCHs which is at least overlapped with the survivor SPS PDSCH in time domain and with different CRC scrambling RNTI than the survivor SPS PDSCH.

In one embodiment, the prioritizing at most the first number of SPS PDSCHs among the set of SPS PDSCHs could be performed and/or repeated based on at least the update of the set of SPS PDSCHs in each step associated to survivor PDSCH in previous step. The prioritizing at most the first number of SPS PDSCHs among the set of SPS PDSCHs could also be performed and/or repeated until the first number of SPS PDSCHs is selected or reached, or the set of SPS PDSCHs is empty.

In one embodiment, G-RNTI or GS-RNTI is at least used for CRC scrambling for multicast transmission, and/or GS-RNTI is at least used for DCI activating SPS configuration for multicast. The first number may be the UE's capability for receiving PDSCH in a slot.

Referring back to FIGS. 3 and 4, in one exemplary embodiment of a UE. The UE 300 includes a program code 312 stored in the memory 310. The CPU 308 could execute program code 312 to enable the UE (i) to receive one or more SPS configurations associated to a BWP, wherein the one or more SPS configurations comprise at least one SPS configuration associated to unicast and one SPS configuration associated to multicast, (ii) to receive one or more DCIs activating the one or more SPS configurations, wherein the one or more (activated) SPS configurations configures the UE to receive a set of SPS PDSCHs comprising a third number of SPS PDSCHs in a slot, (iii) to Prioritizing at most a first number of SPS PDSCHs among the set of SPS PDSCHs based on at least SPS configuration index, wherein the third number is larger than the first number, and wherein the prioritizing at most the first number of SPS PDSCHs among the set of SPS PDSCHs at least comprises: (1) selecting a survivor SPS PDSCH with lowest SPS configuration index among the set of SPS PDSCHs; (2) designating the survivor SPS PDSCH as one of the first number of SPS PDSCHs; and (3) excluding, from the set of SPS PDSCHs, the survivor SPS PDSCH and one or more SPS PDSCHs in the set of SPS PDSCHs which is at least overlapped with the survivor SPS PDSCH in time domain and associated with same cast type as the survivor SPS PDSCH, (iv) to receive and/or decode at most the first number of SPS PDSCHs. Furthermore, the CPU 308 can execute the program code 312 to perform all of the above-described actions and steps or others described herein.

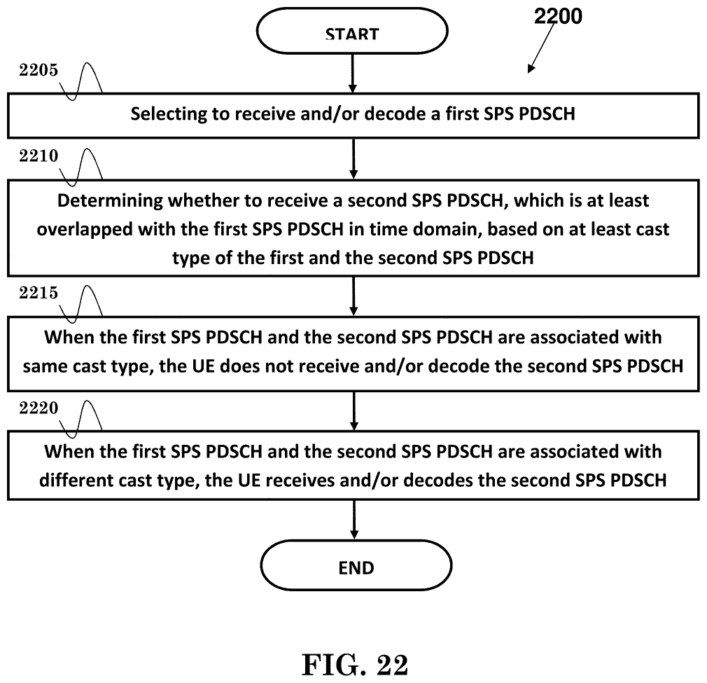

FIG. 22 is a flow chart 2200 according to one exemplary embodiment from the perspective of a UE. In step 2205, the UE selects to receive and/or decode a first SPS PDSCH. In step 2210, the UE determines whether to receive a second SPS PDSCH, which is at least overlapped with the first SPS PDSCH in time domain, based on at least cast type of the first and the second SPS PDSCH. In step 2215, when the first SPS PDSCH and the second SPS PDSCH are associated with same cast type, the UE does not receive and/or decode the second SPS PDSCH. In step 220, when the first SPS PDSCH and the second SPS PDSCH are associated with different cast type, the UE receives and/or decodes the second SPS PDSCH.

In one embodiment, the UE could receive one or more SPS configurations associated to a BWP, wherein the one or more SPS configurations comprise at least a first SPS configuration associated to unicast and a second SPS configuration associated to multicast. The first SPS PDSCH could be based on one of the one or more SPS configurations, and/or the second SPS PDSCH is based on another one of the one or more SPS configurations.

In one embodiment, the UE could receive one or more DCIs activating the one or more SPS configurations, wherein the one or more (activated) SPS configurations configures the UE to receive a set of SPS PDSCHs comprising a third number of SPS PDSCHs in a slot, and the third number is larger than a first number which is UE's capability for receiving PDSCH in a slot.

In one embodiment, the set of SPS PDSCHs may comprise at least the first SPS PDSCH and the second SPS PDSCH. The UE could prioritize to receive the first SPS PDSCH comprises at least prioritizing the first SPS PDSCH as survivor SPS PDSCH among the set of SPS PDSCHs.

In one embodiment, for the first SPS PDSCH being as a survivor SPS PDSCH, the UE could designate the first SPS PDSCH for receiving and/or decoding. The UE could exclude, from the set of SPS PDSCHs, the first SPS PDSCH and one or more SPS PDSCHs which is at least overlapped with the survivor SPS PDSCH in time domain and with same cast type. The UE may not exclude, from the set of SPS PDSCHs, one or more SPS PDSCHs which is at least overlapped with the survivor SPS PDSCH in time domain and with same cast type as the first SPS PDSCH.

In one embodiment, G-RNTI or GS-RNTI could be at least used for CRC scrambling for multicast transmission. GS-RNTI could be at least used for DCI activating SPS configuration for multicast.

In one embodiment, the second SPS PDSCH may not be overlapped with the first SPS PDSCH in frequency domain.

Referring back to FIGS. 3 and 4, in one exemplary embodiment of a UE. The UE 300 includes a program code 312 stored in the memory 310. The CPU 308 could execute program code 312 to enable the UE (i) to selecting to receive and/or decode a first SPS PDSCH, (ii) to determines whether to receive a second SPS PDSCH, which is at least overlapped with the first SPS PDSCH in time domain, based on at least cast type of the first and the second SPS PDSCH, (iii) to not receive and/or decode the second SPS PDSCH when the first SPS PDSCH and the second SPS PDSCH are associated with same cast type, and (iv) to receive and/or decode the second SPS PDSCH when the first SPS PDSCH and the second SPS PDSCH are associated with different cast type. Furthermore, the CPU 308 can execute the program code 312 to perform all of the above-described actions and steps or others described herein.

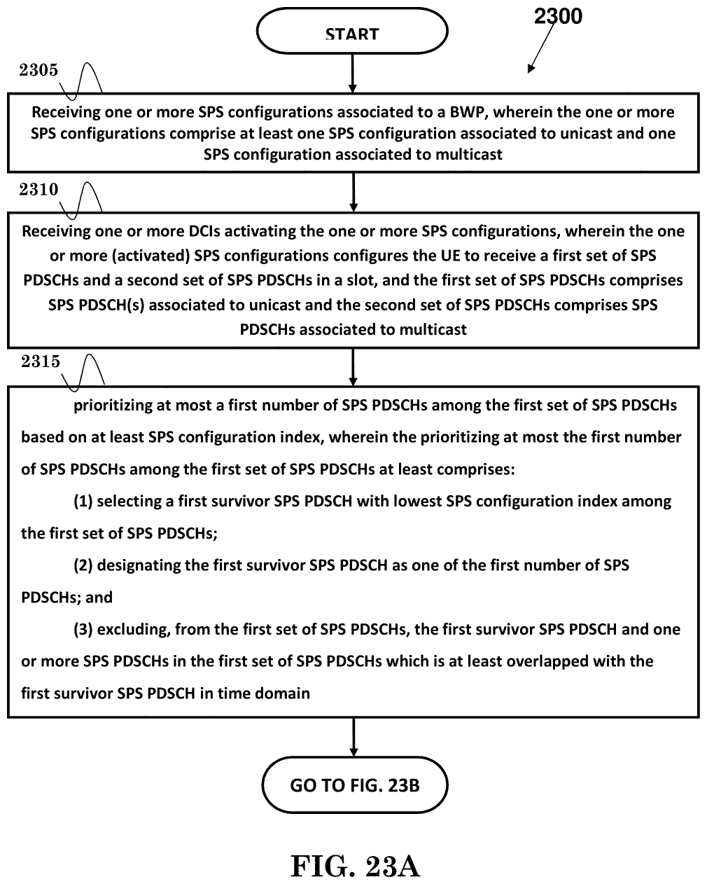

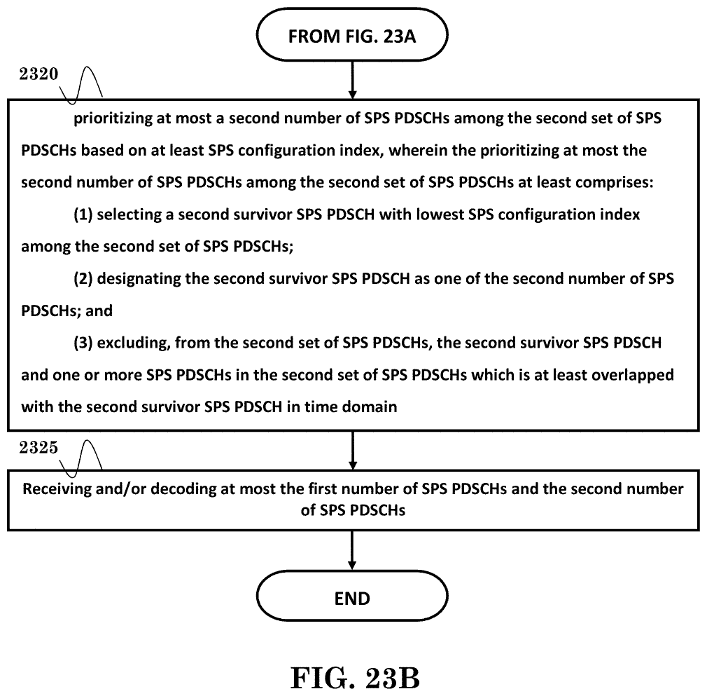

FIGS. 23A and 23B together form a flow chart 2300 according to one exemplary embodiment from the perspective of a UE. In step 2305, the UE receives one or more SPS configurations associated to a BWP, wherein the one or more SPS configurations comprise at least one SPS configuration associated to unicast and one SPS configuration associated to multicast. In step 2310, the UE receives one or more Downlink Control Informations (DCIs) activating the one or more SPS configurations, wherein the one or more (activated) SPS configurations configures the UE to receive a first set of SPS PDSCHs and a second set of SPS PDSCHs in a slot, and the first set of SPS PDSCHs comprises SPS PDSCH(s) associated to unicast and the second set of SPS PDSCHs comprises SPS PDSCHs associated to multicast.

In step 2315, the UE prioritizes at most a first number of SPS PDSCHs among the first set of SPS PDSCHs based on at least SPS configuration index, wherein the prioritizing at most the first number of SPS PDSCHs among the first set of SPS PDSCHs at least comprises:
(1) selecting a first survivor SPS PDSCH with lowest SPS configuration index among the first set of SPS PDSCHs;
(2) designating the first survivor SPS PDSCH as one of the first number of SPS PDSCHs; and
(3) excluding, from the first set of SPS PDSCHs, the first survivor SPS PDSCH and one or more SPS PDSCHs in the first set of SPS PDSCHs which is at least overlapped with the first survivor SPS PDSCH in time domain;

In step 2320, the UE prioritizes at most a second number of SPS PDSCHs among the second set of SPS PDSCHs based on at least SPS configuration index, wherein the prioritizing at most the second number of SPS PDSCHs among the second set of SPS PDSCHs at least comprises:
(1) selecting a second survivor SPS PDSCH with lowest SPS configuration index among the second set of SPS PDSCHs;
(2) designating the second survivor SPS PDSCH as one of the second number of SPS PDSCHs; and
(3) excluding, from the second set of SPS PDSCHs, the second survivor SPS PDSCH and one or more SPS PDSCHs in the second set of SPS PDSCHs which is at least overlapped with the second survivor SPS PDSCH in time domain.

In step 2325, the UE receives and/or decodes at most the first number of SPS PDSCHs and the second number of SPS PDSCHs.

In one embodiment, the first number of SPS PDSCHs may be one and the second number of SPS PDSCHs may be one. When the UE prioritizes at most a first number of SPS PDSCHs among the first set of SPS PDSCHs, the UE may not exclude the one or more SPS PDSCHs in the second set of SPS PDSCHs which is overlapped with the first survivor SPS PDSCH only in time domain.

In one embodiment, G-RNTI or GS-RNTI could be at least used for CRC scrambling for multicast transmission. GS-RNTI could be at least used for DCI activating SPS configuration for multicast.

Referring back to FIGS. 3 and 4, in one exemplary embodiment of a UE. The UE 300 includes a program code 312 stored in the memory 310. The CPU 308 could execute program code 312 to enable the UE (i) to receive one or more SPS configurations associated to a BWP, wherein the one or more SPS configurations comprise at least one SPS configuration associated to unicast and one SPS configuration associated to multicast, (ii) to receive one or more DCIs activating the one or more SPS configurations, wherein the one or more (activated) SPS configurations configures the UE to receive a first set of SPS PDSCHs and a second set of SPS PDSCHs in a slot, and the first set of SPS PDSCHs comprises SPS PDSCH(s) associated to unicast and the second set of SPS PDSCHs comprises SPS PDSCHs associated to multicast, (iii) to prioritize at most a first number of SPS PDSCHs among the first set of SPS PDSCHs based on at least SPS configuration index, wherein the prioritizing at most the first number of SPS PDSCHs among the first set of SPS PDSCHs at least comprises: (1) selecting a first survivor SPS PDSCH with lowest SPS configuration index among the first set of SPS PDSCHs; (2) designating the first survivor SPS PDSCH as one of the first number of SPS PDSCHs; and (3) excluding, from the first set of SPS PDSCHs, the first survivor SPS PDSCH and one or more SPS PDSCHs in the first set of SPS PDSCHs which is at least overlapped with the first survivor SPS PDSCH in time domain, (iv) to prioritize at most a second number of SPS PDSCHs among the second set of SPS PDSCHs based on at least SPS configuration index, wherein the prioritizing at most the second number of SPS PDSCHs among the second set of SPS PDSCHs at least comprises: (1) selecting a second survivor SPS PDSCH with lowest SPS configuration index among the second set of SPS PDSCHs; (2) designating the second survivor SPS PDSCH as one of the second number of SPS PDSCHs; and (3) excluding, from the second set of SPS PDSCHs, the second survivor SPS PDSCH and one or more SPS PDSCHs in the second set of SPS PDSCHs which is at least overlapped with the second survivor SPS PDSCH in time domain, and (v) to receive and/or decode at most the first number of SPS PDSCHs and the second number of SPS PDSCHs. Furthermore, the CPU 308 can execute the program code 312 to perform all of the above-described actions and steps or others described herein.

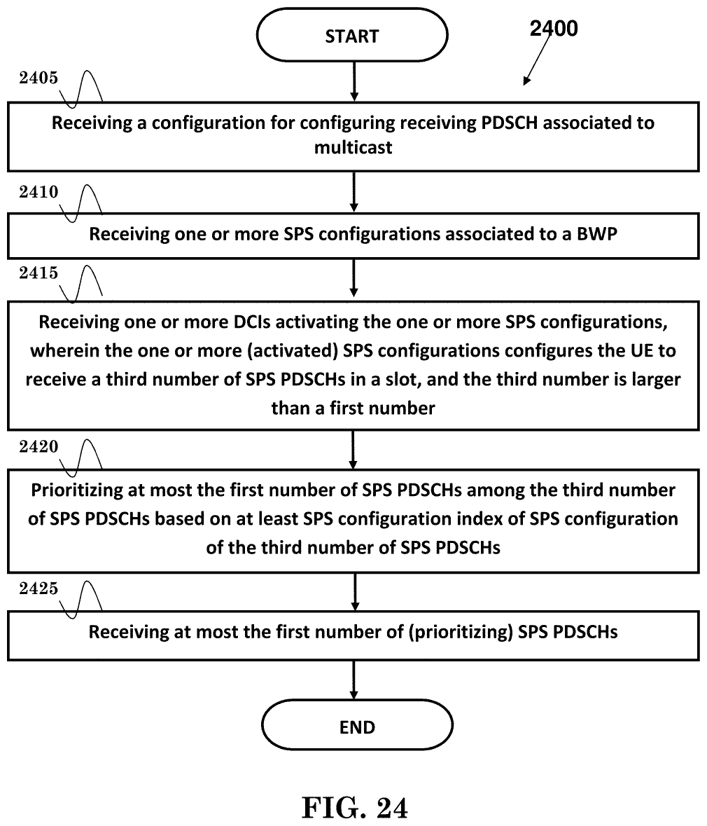

FIG. 24 is a flow chart 2400 according to one exemplary embodiment from the perspective of a UE. In step 2405, the UE receives a configuration for configuring receiving PDSCH associated to multicast. In step 2410, the UE receives one or more SPS configurations associated to a BWP. In step 2415, the UE receives one or more DCIs activating the one or more SPS configurations, wherein the one or more (activated) SPS configurations configures the UE to receive a third number of SPS PDSCHs in a slot, and the third number is larger than a first number. In step 2420, the UE prioritizes at most the first number of SPS PDSCHs among the third number of SPS PDSCHs based on at least SPS configuration index of SPS configuration of the third number of SPS PDSCHs. In step 2425, the UE receives at most the first number of (prioritizing) SPS PDSCHs.

In one embodiment, the prioritizing at most the first number of SPS PDSCHs among the third number of SPS PDSCHs may comprise at least any one or any combination of following: (1) deriving a set of SPS PDSCHs comprising at least the third number of SPS PDSCHs, and/or (2) prioritizing a (survivor) SPS PDSCH with lowest SPS configuration index among the set of SPS PDSCHs, and/or (3) excluding, from the set of SPS PDSCHs, the (survivor) SPS PDSCH and one or more SPS PDSCHs in the set of SPS PDSCHs which is at least overlapped with the (survivor) SPS PDSCH in time domain.

In one embodiment, the prioritizing at most the first number of SPS PDSCHs among the third number of SPS PDSCHs comprises at least any one or any combination of following: (1) excluding, from the set of SPS PDSCHs, the (survivor) SPS PDSCH and one or more SPS PDSCHs in the set of SPS PDSCHs which is at least overlapped with the (survivor) SPS PDSCH in time domain and with same CRC scrambling RNTI as the (survivor) SPS PDSCH, and/or (2) only excluding, from the set of SPS PDSCHs, the (survivor) SPS PDSCH and one or more SPS PDSCHs in the set of SPS PDSCHs which is at least overlapped with the (survivor) SPS PDSCH in time domain and associated with same cast type as the (survivor.) SPS PDSCH, and/or (3) not excluding, from the set of SPS PDSCHs, one or more SPS PDSCHs in the set of SPS PDSCHs which is at least overlapped with the (survivor) SPS PDSCH in time domain and associated with different cast type than the (survivor) SPS PDSCH, and/or (4) only excluding, from the set of SPS PDSCHs, the (survivor) SPS PDSCH and one or more SPS PDSCHs in the set of SPS PDSCHs which is at least overlapped with the (survivor) SPS PDSCH in time domain and with same CRC scrambling RNTI as the (survivor) SPS PDSCH, and/or (5) to excluding, from the set of SPS PDSCHs, one or more SPS PDSCHs in the set of SPS PDSCHs which is at least overlapped with the (survivor) SPS PDSCH in time domain and with different CRC scrambling RNTI than the (survivor) SPS PDSCH.

In one embodiment, the prioritizing at most the first number of SPS PDSCHs among the third number of SPS PDSCHs could be performed and/or repeated based on at least the update of the set of SPS PDSCHs. The prioritizing at most the first number of SPS PDSCHs among the third number of SPS PDSCHs could also be performed and/or repeated based on at least the set of SPS PDSCHs with preferably excluding at least the (last) (survivor) SPS PDSCH. In addition, the prioritizing at most the first number of SPS PDSCHs among the third number of SPS PDSCHs could be performed and/or repeated until the first number of SPS PDSCHs is reached or the set of SPS PDSCHs is empty.

In one embodiment, the prioritizing at most the first number of SPS PDSCHs among the third number of SPS PDSCHs could be performed based on at least increasing order of SPS configuration index in the set of SPS PDSCHs. The prioritizing at most the first number of SPS PDSCHs among the third number of SPS PDSCHs could be performed based on at least following order: M . . . MU . . . U, or U . . . UM, or M . . . MU, or MU, or UM, wherein “M” corresponds to SPS PDSCH for multicast, “U” corresponds to SPS PDSCH for unicast, and the left or the first letter has highest priority or with lowest SPS configuration index among the set of SPS PDSCHs, and/or “MU” or “UM” corresponds to simultaneous reception of one multicast PDSCH and one unicast PDSCH in a slot (no matter or regardless of UE's capability of the first number).

In one embodiment, the UE may not receiving non-prioritizing PDSCH. The one or more SPS configuration may be shared by multicast and unicast. If one of the one or more SPS configurations is activated for multicast, the UE may not expect that the one of the one or more SPS configurations is activated for unicast.

In one embodiment, the UE may not expect that one SPS configuration index, associated to one (activated) SPS configuration for multicast, is used for another (activated) SPS configuration for unicast (unless receiving DCI releasing the one SPS configuration). The UE may not expect to receive the a SPS PDSCH for multicast associated to a SPS configuration which SPS configuration index is the same as SPS configuration index for another SPS configuration associated to an another SPS PDSCH for unicast.

In one embodiment, the UE could report the first number to a network. The first number may at least correspond to the UE's capability of receiving number of PDSCHs in a slot. The UE could report a second number to a network. The second number could be a flag or Boolean number indicating whether the UE supports simultaneous reception of PDSCHs. The second number could at least correspond to the UE's capability of whether support simultaneous reception of PDSCHs, the UE's capability of how many number of simultaneous PDSCH reception, and/or the UE's capability of how many pair of simultaneous of FDM multicast and unicast PDSCH reception.

In one embodiment, the UE could derive the second number based on the first number, and/or the second number is half of the first number preferably with ceil/ceiling or floor function/operation. In response to the one or more DCIs, the UE could receive SPS PDSCH based on at least the one or more (activated) SPS configurations. The UE could receive another one or more DCIs for releasing the one or more SPS configuration. In response to the another one or more DCIs, the UE may not receive SPS PDSCH based on at least the one or more (released) SPS configurations. The one or more DCIs may comprise at least a first DCI and a second DCI. The first DCI could activate the first SPS configuration. The second DCI could activate the second SPS configuration. The first DCI could indicates a first resource, and/or the second DCI could indicate a second resource.

In one embodiment, the one or more SPS configurations may comprise at least a first SPS configuration and a second SPS configuration. The first SPS configuration may be associated with a SPS configuration index being lower than SPS configuration index of the second SPS configuration.

In one embodiment, the third number of SPS PDSCHs may comprise at least a first SPS PDSCH and a second SPS PDSCH. The first SPS PDSCH may be associated to or corresponds to the first SPS configuration. The second SPS PDSCH may be associated to or corresponds to the second SPS configuration. The first SPS PDSCH could be the N-th PDSCH corresponding to the first SPS configuration (in response to the first DCI). The second SPS PDSCH could be the M-th PDSCH corresponding to the second SPS configuration (in response to the second DCI).

In one embodiment, the UE could receive the first SPS PDSCH on the first resource. The UE could also receive the second SPS PDSCH on the second resource.

In one embodiment, the one or more DCIs could be scrambled with G-RNTI or CS-RNTI or GS-RNTI. G-RNTI or GS-RNTI could be at least used for CRC scrambling for multicast transmission. GS-RNTI could be at least used for DCI activating SPS configuration for multicast.

In one embodiment, the UE could determine or derive whether a SPS PDSCH or a SPS PDSCH configuration is associated to or is for multicast or not based on at least the one or more DCIs. The UE could determine or derive whether a SPS PDSCH or a SPS PDSCH configuration is associated to or is for multicast or not based on at least a parameter or a flag in the one or more DCI. The UE could determine or derive whether a SPS PDSCH or a SPS PDSCH configuration is associated to or is for multicast or not based on at least a parameter or a flag in the one or more SPS configurations.

In one embodiment, the parameter or the flag could indicate whether an SPS configuration is at least for multicast or not. The parameter or the flag could also indicate whether an SPS configuration is at least for unicast or not.

In one embodiment, the receiving a configuration for configuring receiving PDSCH associated to multicast may comprise at least configuring an RNTI (e.g., G-RNTI or GS-RNTI) for receiving or monitoring multicast PDSCH. If the first DCI is CRC scrambled with an RNTI for receiving or monitoring multicast PDSCH, the UE could derive the first SPS configuration (activated by the first DCI) is at least for multicast. If the second DCI is CRC scrambled with an RNTI for receiving or monitoring unicast PDSCH, the UE could derive the second SPS configuration (activated by the second DCI) is at least for unicast. The first SPS PDSCH may be associated to or may correspond to multicast, and/or the second SPS PDSCH is associated to or corresponds to unicast.

In one embodiment, the first SPS PDSCH/the first resource/N-th PDSCH could be at least overlapped with the second SPS PDSCH/the second resource/M-th PDSCH in time domain, and the first SPS PDSCH/the first resource/N-th PDSCH is non-overlapped with the second SPS PDSCH/the second resource/M-th PDSCH in frequency domain.

In one embodiment, prioritizing at most the first number of SPS PDSCHs among the third number of SPS PDSCHs may comprise at least any one or any combination of following: (1) prioritizing the first SPS PDSCH/the first resource/N-th PDSCH over the second SPS PDSCH/the second resource/M-th PDSCH, and/or (2) in response to the first SPS PDSCH/the first resource/N-th PDSCH is prioritized, at least one of following: (a) only excluding, from the set of SPS PDSCHs, the first SPS/the first resource/N-th PDSCH and one or more SPS PDSCHs in the set of SPS PDSCHs which is at least overlapped with the (survivor) SPS PDSCH in time domain and associated with same cast type as the first SPS PDSCH/the first resource/N-th PDSCH, or (b) not excluding, from the set of SPS PDSCHs, the second SPS PDSCH/the second resource/M-th PDSCH.

Referring back to FIGS. 3 and 4, in one exemplary embodiment of a UE. The UE 300 includes a program code 312 stored in the memory 310. The CPU 308 could execute program code 312 to enable the UE (i) to receive a configuration for configuring receiving PDSCH associated to multicast, (ii) to receive one or more SPS configurations associated to a BWP, (iii) to receive one or more DCIs activating the one or more SPS configurations, wherein the one or more (activated) SPS configurations configures the UE to receive a third number of SPS PDSCHs in a slot, and the third number is larger than a first number, (iv) to prioritize at most the first number of SPS PDSCHs among the third number of SPS PDSCHs based on at least SPS configuration index of SPS configuration of the third number of SPS PDSCHs, and (v) to receive at most the first number of (prioritizing) SPS PDSCHs. Furthermore, the CPU 308 can execute the program code 312 to perform all of the above-described actions and steps or others described herein.

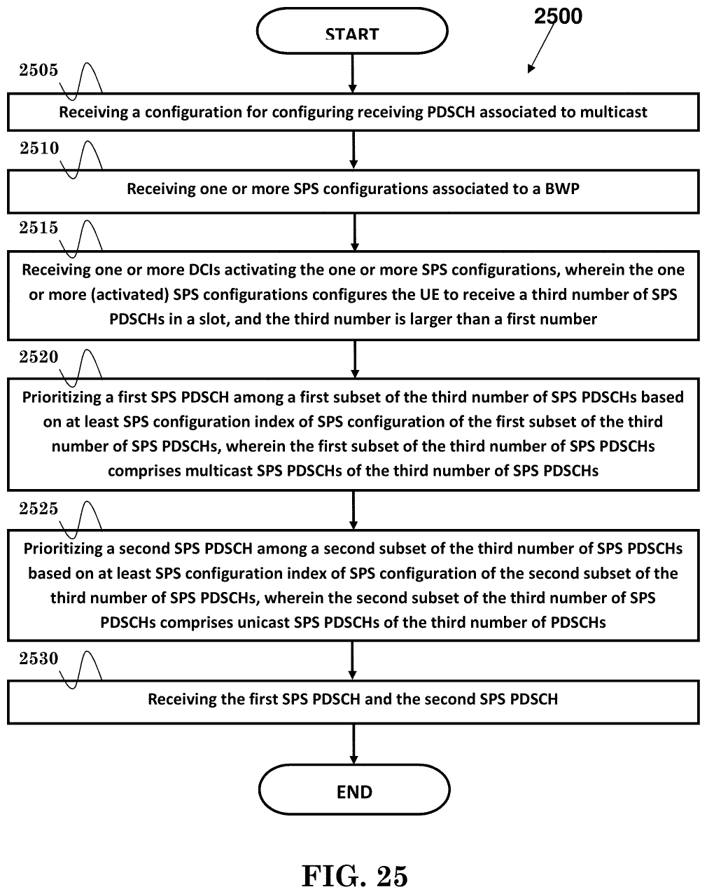

FIG. 25 is a flow chart 2500 according to one exemplary embodiment from the perspective of a UE. In step 2505, the UE receives a configuration for configuring receiving PDSCH associated to multicast. In step 2510, the UE receives one or more SPS configurations associated to a BWP. In step 2515, the UE receives one or more DCIs activating the one or more SPS configurations, wherein the one or more (activated) SPS configurations configures the UE to receive a third number of SPS PDSCHs in a slot, and the third number is larger than a first number. In step 2520, the UE prioritizes a first SPS PDSCH among a first subset of the third number of SPS PDSCHs based on at least SPS configuration index of SPS configuration of the first subset of the third number of SPS PDSCHs, wherein the first subset of the third number of SPS PDSCHs comprises multicast SPS PDSCHs of the third number of SPS PDSCHs. In step 2525, the UE prioritizes a second SPS PDSCH among a second subset of the third number of SPS PDSCHs based on at least SPS configuration index of SPS configuration of the second subset of the third number of SPS PDSCHs, wherein the second subset of the third number of SPS PDSCHs comprises unicast SPS PDSCHs of the third number of SPS PDSCHs. In step 2530, the UE receives the first SPS PDSCH and the second SPS PDSCH.

In one embodiment, the third number of SPS PDSCHs may comprise at least one unicast SPS PDSCH and at least one multicast SPS PDSCH. In response to at least the third number of SPS PDSCHs comprising at least one unicast SPS PDSCH and at least one multicast SPS PDSCH, the UE could perform prioritizing one unicast SPS PDSCH (the second SPS PDSCH) and one multicast SPS PDSCH (the first SPS PDSCH), respectively. In response to at least the at least unicast SPS PDSCH being overlapped with the at least the multicast SPS PDSCH in time domain (and being non-overlapped in frequency domain), the UE could perform prioritizing one unicast SPS PDSCH (the second SPS PDSCH) and one multicast SPS PDSCH (the first SPS PDSCH), respectively. In response to at least the UE supporting simultaneous reception of multicast and unicast PDSCH, the UE could perform prioritizing one unicast SPS PDSCH (the second SPS PDSCH) and one multicast SPS PDSCH (the first SPS PDSCH), respectively. In response to at least the at least multicast SPS PDSCH with SPS configuration index being lower than a first threshold, the UE could perform prioritizing one unicast SPS PDSCH (the second SPS PDSCH) and one multicast SPS PDSCH (the first SPS PDSCH), respectively. In response to at least the at least unicast SPS PDSCH with SPS configuration index being higher than a second threshold, the UE could perform prioritizing one unicast SPS PDSCH (the second SPS PDSCH) and one multicast SPS PDSCH (the first SPS PDSCH), respectively. In response to all unicast SPS PDSCHs of the third number of SPS PDSCHs with SPS configuration index being higher than a second threshold, the UE could perform prioritizing one unicast SPS PDSCH (the second SPS PDSCH) and one multicast SPS PDSCH (the first SPS PDSCH), respectively.

In one embodiment, the second threshold could be the same as or different than the first threshold. The prioritizing the first SPS PDSCH among a first subset of the third number of SPS PDSCHs may comprise at least any one or any combination of following: (1) deriving a set of SPS PDSCHs comprising at least the first subset of the third number of SPS PDSCHs, and/or (2) prioritizing a (survivor) SPS PDSCH with lowest SPS configuration index among the set of SPS PDSCHs, and/or (3) excluding, from the set of SPS PDSCHs, the (survivor) SPS PDSCH and one or more SPS PDSCHs in the set of SPS PDSCHs which is at least overlapped with the (survivor) SPS PDSCH in time domain.

In one embodiment, the prioritizing the second SPS PDSCH among a second subset of the third number of SPS PDSCHs may comprise at least any one or any combination of following: (1) deriving a set of SPS PDSCHs comprising at least the second subset of the third number of SPS PDSCHs, and/or (2) prioritizing a (survivor) SPS PDSCH with lowest SPS configuration index among the set of SPS PDSCHs, and/or (3) excluding, from the set of SPS PDSCHs, the (survivor) SPS PDSCH and one or more SPS PDSCHs in the set of SPS PDSCHs which is at least overlapped with the (survivor) SPS PDSCH in time domain.

Referring back to FIGS. 3 and 4, in one exemplary embodiment of a UE. The UE 300 includes a program code 312 stored in the memory 310. The CPU 308 could execute program code 312 to enable the UE (i) to receive a configuration for configuring receiving PDSCH associated to multicast, (ii) to receive one or more SPS configurations associated to a BWP, (iii) to receive one or more DCIs activating the one or more SPS configurations, wherein the one or more (activated) SPS configurations configures the UE to receive a third number of SPS PDSCHs in a slot, and the third number is larger than a first number, (iv) to prioritize a first SPS PDSCH among a first subset of the third number of SPS PDSCHs based on at least SPS configuration index of SPS configuration of the first subset of the third number of SPS PDSCHs, wherein the first subset of the third number of SPS PDSCHs comprises multicast SPS PDSCHs of the third number of SPS PDSCHs, (v) to prioritize a second SPS PDSCH among a second subset of the third number of SPS PDSCHs based on at least SPS configuration index of SPS configuration of the second subset of the third number of SPS PDSCHs, wherein the second subset of the third number of SPS PDSCHs comprises unicast SPS PDSCHs of the third number of PDSCHs, and (vi) to receive the first SPS PDSCH and the second SPS PDSCH. Furthermore, the CPU 308 can execute the program code 312 to perform all of the above-described actions and steps or others described herein.

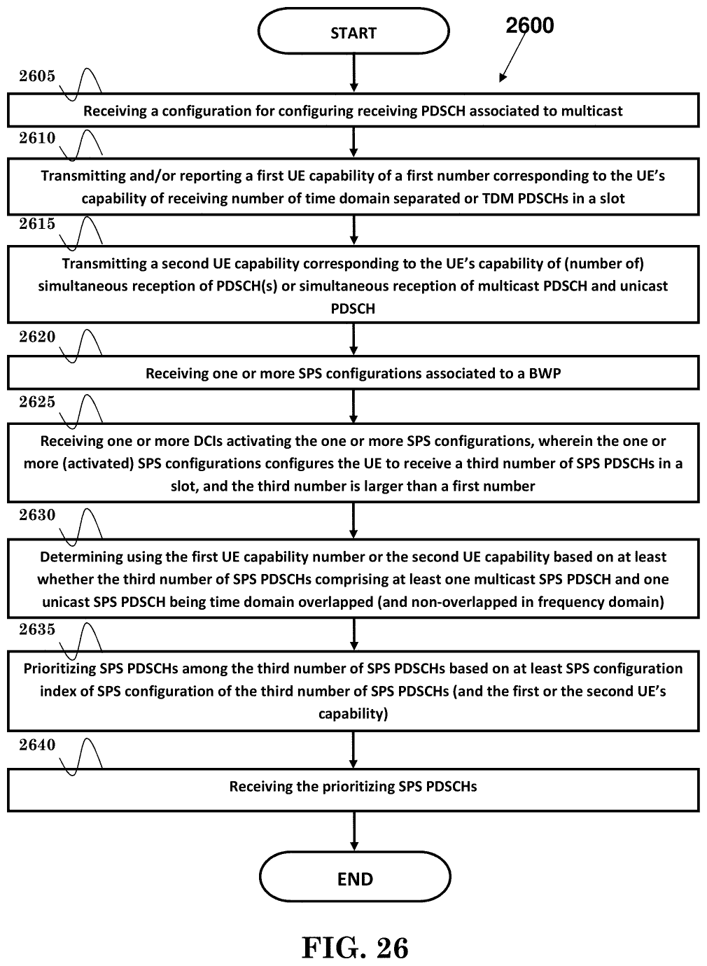

FIG. 26 is a flow chart 2600 according to one exemplary embodiment from the perspective of a UE. In step 2605, the UE receives a configuration for configuring receiving PDSCH associated to multicast. In step 2610, the UE transmits and/or reports a first UE capability of a first number corresponding to the UE's capability of receiving number of time domain separated or Time Division Multiplex (TDM) PDSCHs in a slot. In step 2615, the UE transmits a second UE capability corresponding to the UE's capability of (number of) simultaneous reception of PDSCH(s) or simultaneous reception of multicast PDSCH and unicast PDSCH. In step 2620, the UE receives one or more SPS configurations associated to a BWP. In step 2625, the UE receives one or more DCIs activating the one or more SPS configurations, wherein the one or more (activated) SPS configurations configures the UE to receive a third number of SPS PDSCHs in a slot, and the third number is larger than a first number. In step 2630, the UE determines using the first UE capability or the second UE capability based on at least whether the third number of SPS PDSCHs comprising at least one multicast SPS PDSCH and one unicast SPS PDSCH being time domain overlapped (and non-overlapped in frequency domain). In step 2635, the UE prioritizes SPS PDSCHs among the third number of SPS PDSCHs based on at least SPS configuration index of SPS configuration of the third number of SPS PDSCHs (and the first or the second UE's capability). In step 2640, the UE receives the prioritizing SPS PDSCHs.

In one embodiment, (the) determining using the first UE capability or the second UE capability comprises at least that if the third number of SPS PDSCHs comprises all unicast SPS PDSCHs or all multicast SPS PDSCHs or the third number of SPS PDSCHs does not comprises one multicast SPS PDSCH and one unicast SPS PDSCH being time domain overlapped (and non-overlapped in frequency domain), the UE could determine using the first UE capability. (The) determining using the first UE capability or the second UE capability comprises at least that if the third number of SPS PDSCHs comprises at least one multicast SPS PDSCH and one unicast SPS PDSCH being time domain overlapped (and non-overlapped in frequency domain), the UE could determine using the second UE capability. (The) determining using the first UE capability or the second UE capability comprises at least that if the third number of SPS PDSCHs comprises at least one multicast SPS PDSCH associated with SPS configuration of SPS configuration index being lower than a first threshold, the UE could determine using the second UE capability. (The) determining using the first UE capability or the second UE capability comprises at least that if the third number of SPS PDSCHs does not comprises multicast SPS PDSCH associated with SPS configuration of SPS configuration index being lower than a first threshold, the UE could determine using the first UE capability.

In one embodiment, the second UE capability could be an offset, and/or the offset could be to reduce the first UE capability for simultaneous reception of PDSCH(s).

In one embodiment, the UE could receive at most one pair of multicast SPS PDSCH and unicast SPS PDSCH. In response to the determining using the second UE's capability, the UE may not exclude one multicast SPS PDSCH being at least time domain overlapped with an survivor unicast SPS PDSCH (and not overlapped with the survivor unicast SPS PDSCH in frequency domain) (when the survivor unicast SPS PDSCH is prioritized). In response to the determining using the first UE's capability, the UE could exclude one multicast SPS PDSCH being at least time domain overlapped with an survivor unicast SPS PDSCH (and not overlapped with the survivor unicast SPS PDSCH in frequency domain) (when the survivor unicast SPS PDSCH is prioritized). In response to the determining using the second UE's capability, the UE may not exclude one unicast SPS PDSCH being at least time domain overlapped with an survivor multicast SPS PDSCH (and not overlapped with the survivor multicast SPS PDSCH in frequency domain) (when the survivor multicast SPS PDSCH is prioritized). In response to the determining using the first UE's capability, the UE could exclude one unicast SPS PDSCH being at least time domain overlapped with an survivor multicast SPS PDSCH (and not overlapped with the survivor multicast SPS PDSCH in frequency domain) (when the survivor multicast SPS PDSCH is prioritized).

In one embodiment, (in response to the first UE's capability), the prioritizing SPS PDSCHs among the third number of SPS PDSCHs may comprise at least any one or any combination of following: (1) deriving a set of SPS PDSCHs comprising at least the third number of SPS PDSCHs, and/or (2) prioritizing a (survivor) SPS PDSCH with lowest SPS configuration index among the set of SPS PDSCHs, and/or (3) excluding, from the set of SPS PDSCHs, the (survivor) SPS PDSCH and one or more SPS PDSCHs in the set of SPS PDSCHs which is at least overlapped with the (survivor) SPS PDSCH in time domain.

In one embodiment, (in response to the second UE's capability), the prioritizing SPS PDSCHs among the third number of SPS PDSCHs may comprise at least any one or any combination of following: (1) excluding, from the set of SPS PDSCHs, the (survivor) SPS PDSCH and one or more SPS PDSCHs in the set of SPS PDSCHs which is at least overlapped with the (survivor) SPS PDSCH in time domain and with same CRC scrambling RNTI as the (survivor) SPS PDSCH, and/or (2) only excluding, from the set of SPS PDSCHs, the (survivor) SPS PDSCH and one or more SPS PDSCHs in the set of SPS PDSCHs which is at least overlapped with the (survivor) SPS PDSCH in time domain and associated with same cast type as the (survivor) SPS PDSCH, and/or (3) not excluding, from the set of SPS PDSCHs, one or more SPS PDSCHs in the set of SPS PDSCHs which is at least overlapped with the (survivor) SPS PDSCH in time domain and associated with different cast type than the (survivor) SPS PDSCH, and/or (4) only excluding, from the set of SPS PDSCHs, the (survivor) SPS PDSCH and one or more SPS PDSCHs in the set of SPS PDSCHs which is at least overlapped with the (survivor) SPS PDSCH in time domain and with same CRC scrambling RNTI as the (survivor) SPS PDSCH, and/or (5) not excluding, from the set of SPS PDSCHs, one or more SPS PDSCHs in the set of SPS PDSCHs which is at least overlapped with the (survivor) SPS PDSCH in time domain and with different CRC scrambling RNTI than the (survivor) SPS PDSCH.

In one embodiment, the prioritizing SPS PDSCHs among the third number of SPS PDSCHs could be performed and/or repeated based on at least the update of the set of SPS PDSCHs. The prioritizing SPS PDSCHs among the third number of SPS PDSCHs could be performed and/or repeated based on at least the set of SPS PDSCHs with preferably excluding at least the (last) (survivor) SPS PDSCH. The prioritizing SPS PDSCHs among the third number of SPS PDSCHs could be performed and/or repeated until the first number of SPS PDSCHs is reached or the set of SPS PDSCHs is empty. The prioritizing SPS PDSCHs among the third number of SPS PDSCHs could be performed and/or repeated until the second number of SPS PDSCHs is reached or the set of SPS PDSCHs is empty. The prioritizing SPS PDSCHs among the third number of SPS PDSCHs could be performed and/or repeated until a fourth number which is the first number minus the second number is reached or the set of SPS PDSCHs is empty. The prioritizing SPS PDSCHs among the third number of SPS PDSCHs could be performed based on at least increasing order of SPS configuration index in the set of SPS PDSCHs.

Referring back to FIGS. 3 and 4, in one exemplary embodiment of a UE. The UE 300 includes a program code 312 stored in the memory 310. The CPU 308 could execute program code 312 to enable the UE (i) to receive a configuration for configuring receiving PDSCH associated to multicast, (ii) to transmit and/or report a first UE capability of a first number corresponding to the UE's capability of receiving number of time domain separated or TDM PDSCHs in a slot, (iii) to transmit a second UE capability corresponding to the UE's capability of (number of) simultaneous reception of PDSCH(s) or simultaneous reception of multicast PDSCH and unicast PDSCH, (iv) to receive one or more SPS configurations associated to a BWP, (v) to receive one or more DCIs activating the one or more SPS configurations, wherein the one or more (activated) SPS configurations configures the UE to receive a third number of SPS PDSCHs in a slot, and the third number is larger than a first number, (vi) to determine using the first UE capability or the second UE capability based on at least whether the third number of SPS PDSCHs comprising at least one multicast SPS PDSCH and one unicast SPS PDSCH being time domain overlapped (and non-overlapped in frequency domain), (vii) to prioritize SPS PDSCHs among the third number of SPS PDSCHs based on at least SPS configuration index of SPS configuration of the third number of SPS PDSCHs (and the first or the second UE's capability), and (viii) to receive the prioritizing SPS PDSCHs. Furthermore, the CPU 308 can execute the program code 312 to perform all of the above-described actions and steps or others described herein.

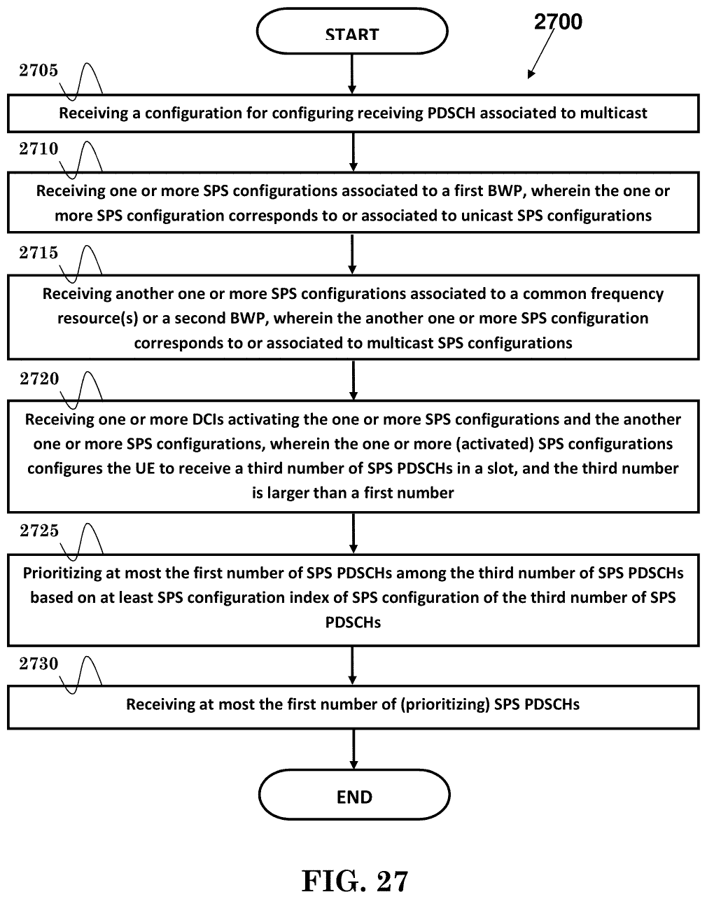

FIG. 27 is a flow chart 2700 according to one exemplary embodiment from the perspective of a UE. In step 2705, the UE receives a configuration for configuring receiving PDSCH associated to multicast. In step 2710, the UE receives one or more SPS configurations associated to a first BWP, wherein the one or more SPS configuration corresponds to or associated to unicast SPS configurations. In step 2715, the UE receives another one or more SPS configurations associated to a common frequency resource(s) or a second BWP, wherein the another one or more SPS configuration corresponds to or associated to multicast SPS configurations. In step 2720, the UE receives one or more DCIs activating the one or more SPS configurations and the another one or more SPS configurations, wherein the one or more (activated) SPS configurations configures the UE to receive a third number of SPS PDSCHs in a slot, and the third number is larger than a first number. In step 2725, the UE prioritizes at most the first number of SPS PDSCHs among the third number of SPS PDSCHs based on at least SPS configuration index of SPS configuration of the third number of SPS PDSCHs. In step 2730, the UE receives at most the first number of (prioritizing) SPS PDSCHs.

In one embodiment, wherein the first BWP comprises the common frequency resource(s) or the second BWP. The UE may not expect that sum of the one or more SPS configurations and the another one or more SPS configurations is larger than a maximum number of SPS configuration (associated to a BWP or the first BWP). The UE may not expect that number of activated SPS configuration from the one or more SPS configurations and the another one or more SPS configurations is not larger than a maximum number of SPS configuration (associated to a BWP or the first BWP). The UE may not expect to receive the one or more DCIs activating one SPS configuration with a SPS configuration index which is the same as another activated SPS configuration index.

In one embodiment, the prioritizing at most the first number of SPS PDSCHs among the third number of SPS PDSCHs could be performed based on at least following order: M1, . . . , M8, U1, . . . , U8, or U1, . . . , U8, M, or M1, . . . , M8, U, or MU, or UM, wherein “Mi” corresponds to SPS PDSCH for multicast associated SPS configuration with SPS configuration index, i, “Ui” corresponds to SPS PDSCH for unicast associated SPS configuration with SPS configuration index, i, “M” corresponds to SPS PDSCH for multicast (with lowest SPS configuration index among the set of SPS PDSCHs being for multicast), “U” corresponds to SPS PDSCH for unicast (with lowest SPS configuration index among the set of SPS PDSCHs being for unicast).

Referring back to FIGS. 3 and 4, in one exemplary embodiment of a UE. The UE 300 includes a program code 312 stored in the memory 310. The CPU 308 could execute program code 312 to enable the UE (i) to receive a configuration for configuring receiving PDSCH associated to multicast, (ii) to receive one or more SPS configurations associated to a first BWP, wherein the one or more SPS configuration corresponds to or associated to unicast SPS configurations, (iii) to receive another one or more SPS configurations associated to a common frequency resource(s) or a second BWP, wherein the another one or more SPS configuration corresponds to or associated to multicast SPS configurations, (iv) to receive one or more DCIs activating the one or more SPS configurations and the another one or more SPS configurations, wherein the one or more (activated) SPS configurations configures the UE to receive a third number of SPS PDSCHs in a slot, and the third number is larger than a first number, (v) to prioritize at most the first number of SPS PDSCHs among the third number of SPS PDSCHs based on at least SPS configuration index of SPS configuration of the third number of SPS PDSCHs, and (vi) to receive at most the first number of (prioritizing) SPS PDSCHs. Furthermore, the CPU 308 can execute the program code 312 to perform all of the above-described actions and steps or others described herein.

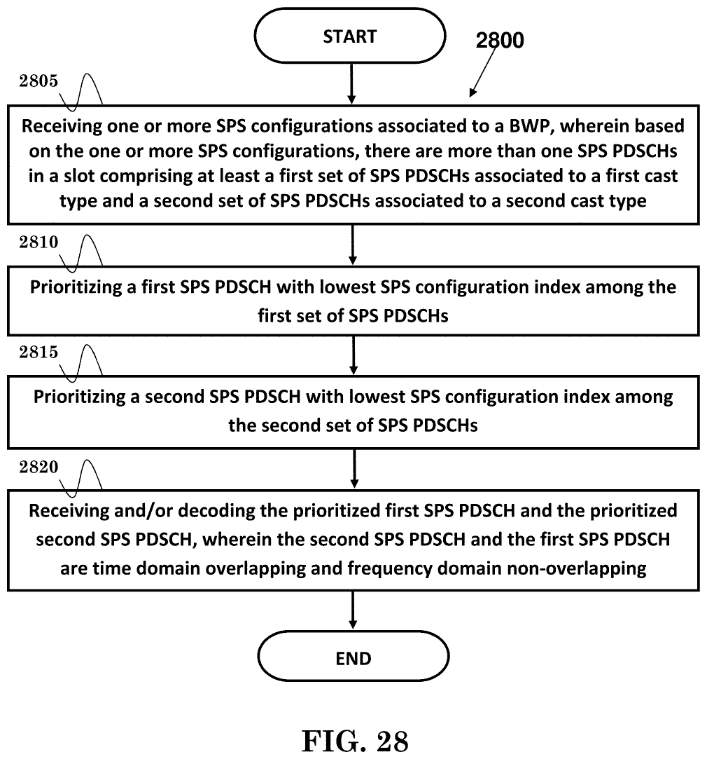

FIG. 28 is a flow chart 2800 according to one exemplary embodiment from the perspective of a UE. In step 2805, the UE receives one or more SPS configurations associated to a BWP, wherein based on the one or more SPS configurations, there are more than one SPS PDSCHs in a slot comprising at least a first set of SPS PDSCHs associated to a first cast type and a second set of SPS PDSCHs associated to a second cast type. In step 2810, the UE prioritizes a first SPS PDSCH with lowest SPS configuration index among the first set of SPS PDSCHs. In step 2815, the UE prioritizes a second SPS PDSCH with lowest SPS configuration index among the second set of SPS PDSCHs. In step 2820, the UE receives and/or decodes the prioritized first SPS PDSCH and the prioritized second SPS PDSCH, wherein the second SPS PDSCH and the first SPS PDSCH are time domain overlapping and frequency domain non-overlapping.

In one embodiment, the first cast type could be unicast and the second cast type could be multicast. Alternatively, the first cast type could be multicast and the second cast type could be unicast.

In one embodiment, the UE may have capability to simultaneously receive one PDSCH associated to the first cast type and one PDSCH associated to the second cast type. The UE could support at least two capability of receiving PDSCH, wherein a first capability corresponds to receiving a first number of time domain division PDSCHs in a slot, and a second capability corresponds to receiving a second number of PDSCHs in a slot. The second number could be two.

In one embodiment, the first capability may correspond to same cast type PDSCHs. The second capability may correspond to different cast type PDSCHs which are time domain overlapping but frequency domain non-overlapping.

In one embodiment, the more than one SPS PDSCHs may be time domain overlapping and frequency domain non-overlapping. The UE could determine using which capability in a slot for prioritizing SPS PDSCH based on whether there are more than one cast type SPS PDSCH in the slot. When a first slot comprises at least one SPS PDSCH associated to a first cast type and at least one SPS PDSCH associated to a second cast type, the UE could prioritize one SPS PDSCH associated to the first cast type and one SPS PDSCH associated to the second cast type in the first slot. When a second slot comprises SPS PDSCH(s) associated to either a first cast type or a second cast type, the UE could prioritize the first number of SPS PDSCHs in the second slot.

Referring back to FIGS. 3 and 4, in one exemplary embodiment of a UE. The UE 300 includes a program code 312 stored in the memory 310. The CPU 308 could execute program code 312 to enable the UE (i) to receive one or more SPS configurations associated to a BWP, wherein based on the one or more SPS configurations, there are more than one SPS PDSCHs in a slot comprising at least a first set of SPS PDSCHs associated to a first cast type and a second set of SPS PDSCHs associated to a second cast type, (ii) to prioritize a first SPS PDSCH with lowest SPS configuration index among the first set of SPS PDSCHs, (iii) to prioritize a second SPS PDSCH with lowest SPS configuration index among the second set of SPS PDSCHs, and (iv) to receive and/or decode the prioritized first SPS PDSCH and the prioritized second SPS PDSCH, wherein the second SPS PDSCH and the first SPS PDSCH are time domain overlapping and frequency domain non-overlapping. Furthermore, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a User Equipment (UE), comprising:
receiving one or more Semi-Persistent Scheduling (SPS) configurations associated to a Bandwidth Part (BWP), wherein the one or more SPS configurations comprise at least one SPS configuration associated to unicast and one SPS configuration associated to multicast;
receiving one or more Downlink Control Informations (DCIs) activating the one or more SPS configurations, wherein the one or more activated SPS configurations configures the UE to receive a set of SPS Physical Downlink Shared Channels (PDSCHs) comprising a third number of SPS PDSCHs in a slot;
prioritizing at most a first number of SPS PDSCHs among the set of SPS PDSCHs based on at least SPS configuration index, wherein the third number is larger than the first number, and wherein the prioritizing at most the first number of SPS PDSCHs among the set of SPS PDSCHs at least comprises:
(1) selecting a survivor SPS PDSCH with lowest SPS configuration index among the set of SPS PDSCHs; and
(2) designating the survivor SPS PDSCH as one of the first number of SPS PDSCHs; and
(3) excluding, from the set of SPS PDSCHs, the survivor SPS PDSCH and one or more SPS PDSCHs in the set of SPS PDSCHs which is at least overlapped with the survivor SPS PDSCH in time domain and associated with same cast type as the survivor SPS PDSCH; and
receiving and/or decoding at most the first number of SPS PDSCHs.

2. The method of claim 1, wherein the prioritizing at most the first number of SPS PDSCHs among the set of SPS PDSCHs comprises at least any one or any combination of following:
excluding, from the set of SPS PDSCHs, the survivor SPS PDSCH and one or more SPS PDSCHs in the set of SPS PDSCHs which is at least overlapped with the survivor SPS PDSCH in time domain and with a same cyclic redundancy check (CRC) scrambling Radio Network Temporary Identifier (RNTI) as the survivor SPS PDSCH, and/or
not excluding, from the set of SPS PDSCHs, one or more SPS PDSCHs in the set of SPS PDSCHs which is at least overlapped with the survivor SPS PDSCH in time domain and associated with different cast type than the survivor SPS PDSCH, and/or
excluding, from the set of SPS PDSCHs, the survivor SPS PDSCH and one or more SPS PDSCHs in the set of SPS PDSCHs which is at least overlapped with the survivor SPS PDSCH in time domain and with same CRC scrambling RNTI as the survivor SPS PDSCH, and/or
not excluding, from the set of SPS PDSCHs, one or more SPS PDSCHs in the set of SPS PDSCHs which is at least overlapped with the survivor SPS PDSCH in time domain and with different CRC scrambling RNTI than the survivor SPS PDSCH.

3. The method of claim 1, wherein the prioritizing at most the first number of SPS PDSCHs among the set of SPS PDSCHs is performed and/or repeated based on at least the update of the set of SPS PDSCHs in each step associated to survivor PDSCH in previous step.

4. The method of claim 1, wherein the prioritizing at most the first number of SPS PDSCHs among the set of SPS PDSCHs is performed and/or repeated until the first number of SPS PDSCHs is selected or reached, or the set of SPS PDSCHs is empty.

5. The method of claim 1, wherein Group Radio Network Temporary Identifier (G-RNTI) or GS-RNTI is at least used for CRC scrambling for multicast transmission, and/or GS-RNTI is at least used for DCI activating SPS configuration for multicast.

6. The method of claim 1, wherein the first number is UE's capability for receiving PDSCH in a slot.

7. A method for a User Equipment (UE), comprising:
receiving one or more Semi-Persistent Scheduling (SPS) configurations associated to a Bandwidth Part (BWP), wherein based on the one or more SPS configurations, there are more than one SPS Physical Downlink Shared Channels (PDSCHs) in a slot comprising at least a first set of SPS PDSCHs associated to a first cast type and a second set of SPS PDSCHs associated to a second cast type;
prioritizing a first SPS PDSCH with lowest SPS configuration index among the first set of SPS PDSCHs;
prioritizing a second SPS PDSCH with lowest SPS configuration index among the second set of SPS PDSCHs; and
receiving and/or decoding the prioritized first SPS PDSCH and the prioritized second SPS PDSCH, wherein the second SPS PDSCH and the first SPS PDSCH are time domain overlapping and frequency domain non-overlapping.

8. The method of claim 7, wherein the first cast type is unicast and the second cast cast type is multicast, or the first cast type is multicast and the second cast type is unicast.

9. The method of claim 7, the UE has capability to simultaneously receive one PDSCH associated to the first cast type and one PDSCH associated to the second cast type.

10. The method of claim 7, wherein the UE supports at least two capability of receiving PDSCH, wherein a first capability corresponds to receiving a first number of time domain division PDSCHs in a slot, and a second capability corresponds to receiving a second number of PDSCHs in a slot, and/or
the second number is two.

11. The method of claim 10, the first capability corresponds to same cast type PDSCHs, and/or
the second capability corresponds to different cast type PDSCHs which are time domain overlapping but frequency domain non-overlapping.

12. The method of claim 7, wherein the more than one SPS PDSCHs are time domain overlapping and frequency domain non-overlapping.

13. The method of claim 10, the UE determines using which capability in a slot for prioritizing SPS PDSCH based on whether there are more than one cast type SPS PDSCH in the slot, and/or
when a first slot comprises at least one SPS PDSCH associated to a first cast type and at least one SPS PDSCH associated to a second cast type, the UE prioritizing one SPS PDSCH associated to the first cast type and one SPS PDSCH associated to the second cast type in the first slot, and/or
when a second slot comprises SPS PDSCH(s) associated to either a first cast type or a second cast type, the UE prioritizes the first number of SPS PDSCHs in the second slot.

14. A method for a User Equipment (UE), comprising:
receiving one or more Semi-Persistent Scheduling (SPS) configurations associated to a Bandwidth Part (BWP), wherein the one or more SPS configurations comprise at least one SPS configuration associated to unicast and one SPS configuration associated to multicast;
receiving one or more Downlink Control Informations (DCIs) activating the one or more SPS configurations, wherein the one or more activated SPS configurations configures the UE to receive a first set of SPS PDSCHs and a second set of SPS PDSCHs in a slot, and the first set of SPS PDSCHs comprises SPS PDSCH(s) associated to unicast and the second set of SPS PDSCHs comprises SPS PDSCHs associated to multicast;
prioritizing at most a first number of SPS PDSCHs among the first set of SPS PDSCHs based on at least SPS configuration index, wherein the prioritizing at most the first number of SPS PDSCHs among the first set of SPS PDSCHs at least comprises:
(1) selecting a first survivor SPS PDSCH with lowest SPS configuration index among the first set of SPS PDSCHs;
(2) designating the first survivor SPS PDSCH as one of the first number of SPS PDSCHs; and
(3) excluding, from the first set of SPS PDSCHs, the first survivor SPS PDSCH and one or more SPS PDSCHs in the first set of SPS PDSCHs which is at least overlapped with the first survivor SPS PDSCH in time domain;
prioritizing at most a second number of SPS PDSCHs among the second set of SPS PDSCHs based on at least SPS configuration index, wherein the prioritizing at most the second number of SPS PDSCHs among the second set of SPS PDSCHs at least comprises:
(1) selecting a second survivor SPS PDSCH with lowest SPS configuration index among the second set of SPS PDSCHs;
(2) designating the second survivor SPS PDSCH as one of the second number of SPS PDSCHs; and
(3) excluding, from the second set of SPS PDSCHs, the second survivor SPS PDSCH and one or more SPS PDSCHs in the second set of SPS PDSCHs which is at least overlapped with the second survivor SPS PDSCH in time domain; and
receiving and/or decoding at most the first number of SPS PDSCHs and the second number of SPS PDSCHs.

15. The method of claim 14, wherein the first number of SPS PDSCHs is one and the second number of SPS PDSCHs is one.

16. The method of claim 14, wherein when the UE prioritizes at most a first number of SPS PDSCHs among the first set of SPS PDSCHs, the UE does not exclude the one or more SPS PDSCHs in the second set of SPS PDSCHs which is overlapped with the first survivor SPS PDSCH only in time domain.

17. The method of claim 14, wherein Group Radio Network Temporary Identifier (G-RNTI) or GS-RNTI is at least used for CRC scrambling for multicast transmission, and/or GS-RNTI is at least used for DCI activating SPS configuration for multicast.
